(19) United States
(12) Patent Application Publication
(10) Pub. No.: US 2024/0073216 A1
(43) Pub. Date: Feb. 29, 2024

(54) SYSTEM AND METHOD FOR DETERMINATION OF COMMON OR UNIQUE ACCESS ITEMS IN IDENTITY MANAGEMENT ARTIFICIAL INTELLIGENCE SYSTEMS

(71) Applicant: SailPoint Technologies, Inc., Wilmington, DE (US)

(72) Inventors: Jostine Fei Ho, Austin, TX (US); Sana Amin Rajani, Cincinnati, OH (US); Mohamed M. Badawy, Round Rock, TX (US); Quoc Co Tran, Houston, TX (US)

(21) Appl. No.: 18/456,560

(22) Filed: Aug. 28, 2023

Related U.S. Application Data
(60) Provisional application No. 63/401,763, filed on Aug. 29, 2022.

(51) Int. Cl. H04L 9/40; H04L 41/16

(52) U.S. Cl. CPC H04L 63/102; H04L 41/16; H04L 63/20

(57) ABSTRACT

Methods and systems for identity governance that provide for the identification of common or unique access items (e.g., identity management artifacts that may grant access). Certain embodiments may leverage representative data structures that represent an enterprise's identity management data to determine common or unique identity management access items represented in those data structures. In other embodiments, a machine learning model may be trained based on identity management data and utilize predictive scores to determine common or unique identity management access items.

### RELATED APPLICATIONS

This application claims the benefit of priority under 35 U.S.C. § 119 to U.S. Provisional Application No. 63/401,763, filed Aug. 29, 2022, entitled, “SYSTEM AND METHOD FOR DETERMINATION OF COMMON OR UNIQUE ACCESS ITEMS IN IDENTITY MANAGEMENT ARTIFICIAL INTELLIGENCE SYSTEMS USING ANALYSIS OF NETWORK IDENTITY GRAPHS,” which is hereby fully incorporated by reference herein for all purposes.

### COPYRIGHT NOTICE

A portion of the disclosure of this patent document contains material to which a claim for copyright is made. The copyright owner has no objection to the facsimile reproduction by anyone of the patent document or the patent disclosure, as it appears in the Patent and Trademark Office patent file or records, but reserves all other copyright rights whatsoever.

### TECHNICAL FIELD

This disclosure relates generally to computer security. In particular, this disclosure relates to the application of artificial intelligence to identity management in a distributed and networked computing environment. Even more specifically, this disclosure relates to enhancing computer security in a distributed networked computing environment through the determination of common or unique access items (e.g., roles or entitlements) in these artificial intelligence based identity management systems, including the use of machine learning analysis of identity management data or graph based analysis of roles or their associated entitlements in association with such determinations.

### BACKGROUND

Acts of fraud, data tampering, privacy breaches, theft of intellectual property, and exposure of trade secrets have become front page news in today's business world. The security access risk posed by insiders—persons who are granted access to information assets—is growing in magnitude, with the power to damage brand reputation, lower profits, and erode market capitalization.

Identity Management (IM), also known as Identity and Access Management (IAM) or Identity Governance (IG), is, the field of computer security concerned with the enablement and enforcement of policies and measures which allow and ensure that the right individuals access the right resources at the right times and for the right reasons. It addresses the need to ensure appropriate access to resources across increasingly heterogeneous technology environments and to meet increasingly rigorous compliance requirements. Escalating security and privacy concerns are driving governance, access risk management, and compliance to the forefront of identity management. To effectively meet the requirements and desires imposed upon enterprises for identity management, these enterprises may be required to prove that they have strong and consistent controls over who has access to critical applications and data. And, in response to regulatory requirements and the growing security access risk, most enterprises have implemented some form of user access or identity governance.

Yet many companies still struggle with how to focus compliance efforts to address actual risk in what usually is a complex, distributed networked computing environment. Decisions about which access entitlements are desirable to grant a particular user are typically based on the roles that the user plays within the organization. In large organizations, granting and maintaining user access entitlements is a difficult and complex process, involving decisions regarding whether to grant entitlements to thousands of users and hundreds of different applications and databases. This complexity can be exacerbated by high employee turnover, reorganizations, and reconfigurations of the various accessible systems and resources.

Organizations that are unable to focus their identity compliance efforts on areas of greatest access risk can waste time, labor, and other resources applying compliance monitoring and controls across the board to all users and all applications. Furthermore, with no means to establish a baseline measurement of identity compliance, organizations have no way to quantify improvements over time and demonstrate that their identity controls are working and effectively reducing access risk.

Information Technology (IT) personnel of large organizations often feel that their greatest security risks stem from “insider threats,” as opposed to external attacks. The access risks posed by insiders range from careless negligence to more serious cases of financial fraud, corporate espionage, or malicious sabotage of systems and data. Organizations that fail to proactively manage user access can face regulatory fines, litigation penalties, public relations fees, loss of customer trust, and ultimately lost revenue and lower stock valuation. To minimize the security risk posed by insiders (and outsiders), business entities and institutions alike often establish access or other governance policies that eliminate or at least reduce such access risks and implement proactive oversight and management of user access entitlements to ensure compliance with defined policies and other good practices.

One of the main goals of identity management, then, is to help users identify and mitigate risks associated with access management. Many times this access risk may result as an outgrowth of the evolution of roles or distribution of entitlements within an enterprise over time. As roles have entitlements added or deleted and as different roles or entitlements are assigned or removed from different identities these changes may create a complex system that evolves in unpredictable ways over time. As the roles, entitlements, and identities evolve, they may stray in substantial and detrimental ways from the ‘gold standard’ of the role definition or other identity governance desires of the enterprise. While some enterprises manage to iteratively engineer or re-design or re-define their role structures and access model to keep pace with security requirements, the majority of enterprises are unaware of the efficacy of their access security due to the lack of abilities to monitor and evaluate efficacy of overall access landscape, especially in the context of roles defined for, or utilized by, the enterprise.

Yet many companies still struggle with how to focus compliance efforts to address actual risk in what usually is a complex, distributed networked computing environment. Decisions about which access entitlements are desirable to grant a particular user are typically based on the roles that the user plays within the organization. In large organizations, granting and maintaining user access entitlements is a difficult and complex process, involving decisions regarding whether to grant entitlements to thousands of users and hundreds of different applications and databases. This complexity can be exacerbated by high employee turnover, reorganizations, and reconfigurations of the various accessible systems and resources.

Accordingly, it is desirable for identity management solutions to offer tools to assist in the assignment and distribution of roles, assignments, or other access items (i.e., identity management artifacts) associated with the identity management data of an enterprise.

### SUMMARY

As mentioned, it is desirable for identity management solutions to offer assessments of access items whereby access items such as entitlements or roles comprising collections of entitlements may be assessed. By assessing such access items common or unique access items may be identified and utilized in the creation, assessment or use of access models, including the reduction of “noisy” access items in the construction of access models, use for compliance purposes, to assist in optimizing a role or entitlement structure, or more generally streamlining role management for the enterprise. What is desired, therefore, are effective systems and methods for identifying common or unique access items in the identity management data of an enterprise.

To those ends, among others, attention is now directed to the embodiments of artificial intelligence based identity governance systems that provide for the identification of common or unique access items (e.g., identity management artifacts that may grant access). As may be seen, one embodiment may determine common access items utilizing concurrency of the access item as determined from obtained identity management data or representation thereof. In other embodiments, a machine learning model (such as an isolation forest model or extended isolation forest model among for example) may be trained based on such identity management data and utilized predictive scores for commonality.

To illustrate in more detail, certain embodiments may leverage representative data structures that represent an enterprise's identity management data to determine common or unique identity management access items (e.g., roles or entitlements) represented in those data structures. Thus, embodiments may determine common access items utilizing concurrency of the access item as determined from data structures generated based on obtained identity management data. Specifically, embodiments of the identity management systems disclosed herein may utilize a network graph approach to improve identity governance, including the assessment of roles associated with the identity management data of an enterprise. For example, assessment of the distribution (e.g., commonality or uniqueness) of access items may be determined based on a network graph that includes access items of an enterprise.

In one embodiment, for example, a network identity graph may be a graph that is modeled in terms of similarities (concurrency) between access items. This network identity graph may be used to determine which of the represented access items are common. In particular, using the concurrency determined for access items, the distribution of access items based on the concurrency degrees can be determined. Common access items can then be identified using this distribution.

This approach to identifying common access items is not without problems. As one example, this approach relies on a representation of the identity management structure of the enterprise. As such it is highly dependent on the quality of that identity management structure of the enterprise itself. It is typically the case that these portions of the identity management structure are created and maintained by the enterprise. In many instances this is accomplished in a manual fashion. Such structures are often messy and poorly maintained (e.g., infrequently managed or updated). If the identity management structure maintained by an enterprise is deficient, it likewise adversely impacts that ability of a method that utilizes such a structure to accurately or effectively determine common access items from that deficient identity management structure. Moreover, it is less than desirable to offer identity management functionality to an enterprise and then put the onus and responsibility for the quality of such identity management on that very enterprise.

It would be more desirable, therefore, to employ an approach to determining common access items that are both simpler and more accurate. Accordingly, embodiments of this approach may require only the identities and corresponding assigned entitlements which are a reflection of the base level data maintained by source systems within the enterprise. Thus, one embodiment for determining common or unique access items may employ a machine learning model (such as an isolation forest model or extended isolation forest model) trained based on identity management data obtained from an enterprise, where that machine learning model may be trained to, and utilized for, generating predictive scores for commonality for access items. This predictive score can then be used with a threshold to determine common or unique access items in that identity management data or predicting common or unique access items in new, updated or different identity management data.

Such a model (e.g., a machine learning model) may also be used in association with an (e.g., independent) interpreter. This interpreter may be queried to provide explanations in terms of how much and what type (positive or negative) of influence did certain features have over the model's prediction. Features that resulted in the prediction or determination for a common access item can then be returned to a user.

Embodiments provide numerous advantages. Embodiments of identity management systems may allow an accurate approach to common or unique access items in identity governance. This will allow the identification and assessment of the access items of an enterprise identity management structure and the evolution of such an identity management structure. Ultimately, this will yield an improved system that will accurately match the evolving access structure.

Moreover, the graph format or machine learning used by certain embodiments, allows the translation of domain and enterprise specific concepts, phenomena, and issues into tangible, quantifiable, and verifiable hypotheses which may be examined or validated with graph-based algorithms. Accordingly, embodiments may be especially useful in assessing risk and in compliance with security policies or the like.

Additionally, embodiments as disclosed may offer the technological improvement of reducing the computational burden and memory requirements of systems implementing these embodiments through the improved data structures and analysis implemented by such embodiments. Accordingly, embodiments may improve the performance and responsiveness of identity management systems that utilize such embodiments of identity graphs and machine learning approaches by reducing the computation time and processor cycles required (e.g., and thus improving processing speed) and simultaneously reducing memory usage or other memory requirements.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE FIGURES

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 is a block diagram of a distributed networked computer environment including one embodiment of an identity management system.

FIG. 2 is a flow diagram of one embodiment of a method for determining network identity graphs.

FIG. 3 depicts a visual representation of one example of an identity graph.

FIG. 4 is a flow diagram of one embodiment of a method for determining common or unique access items.

FIG. 5 is a block diagram of a distributed networked computer environment including one embodiment of an identity management system.

FIG. 6 is a plot of example data.

FIG. 7 is a flow diagram of one embodiment of a method for determining common or unique access items.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

Before delving into more detail regarding the specific embodiments disclosed herein, some context may be helpful. As discussed previously, it is desirable for identity management solutions to offer assessments of access items such as entitlements or roles comprising collections of entitlements. By assessing such access items, common or unique access items (i.e., identity management artifacts such as roles or entitlements that are commonly or more infrequently assigned to other identity management artifacts such as identities) may be identified and utilized in the creation, assessment or use of access models, including the reduction of “noisy” access items in the construction of access models, use for compliance purposes, to assist in optimizing a role or entitlement structure, or more generally streamlining role management for the enterprise. Effective systems and methods for identifying these common or unique access items from the identity management data of an enterprise are thus desired.

To address those, and other, desires, attention is now directed to the embodiments of artificial intelligence based identity governance systems that provide for the identification of common or unique access items (e.g., identity management artifacts that may grant access). Certain embodiments may leverage representative data structures that represent an enterprise's identity management data to determine common or unique identity management artifacts (e.g., roles or entitlements) represented in those data structures. Thus, embodiments may determine common access items utilizing concurrency of the access item as determined from data structures generated based on obtained identity management data. Specifically, embodiments of the identity management systems disclosed herein may utilize a network graph approach to improve identity governance, including the assessment of roles associated with the identity management data of an enterprise. For example, assessment of the distribution (e.g., commonality or uniqueness) of roles may be determined based on a network graph that includes roles of an enterprise.

Embodiments may thus generate a network identity graph that includes nodes for identities, entitlements, roles or other identity management artifacts of an enterprise. Such a network identity graph may be, or may include, a role graph having nodes representing roles associated with the enterprise and edges representing similarities between the roles (e.g., represented by the nodes). These edges may comprise a similarity weight determined, based on, for example, shared entitlements between the roles or by concurrent identities (e.g., a number of identities that share those roles).

In one embodiment, for example, the role graph may be an identity role graph that is a role graph modeled in terms of identity similarities (concurrency) between roles. A weight may be computed for the identity similarity relationship based on the identities shared (or not shared) between the two roles and the number of identities assigned to each role. Embodiments of these identity role graphs may give high-level abstractions of the overall access model of an enterprise while reflecting the global role (access) structure.

This identity role graph may be used to determine which of the represented roles are common. In particular, using the concurrency determined for each role, the distribution of roles based on the concurrency degrees can be determined. Common roles can then be identified using this distribution. Such common roles can then be identified to a user (e.g., a user associated with an enterprise). Such an approach may be applied similarly to entitlements to determine common access entitlement (e.g., determine a concurrency for those entitlements based on commonly assigned identities and determining common access entitlements based on the distribution of identities based on the concurrency degree).

This approach to identifying common access items is not without problems. As one example, this approach does not account for how roles that are common (e.g., common access roles) can inflate their own concurrency degrees (i.e. a common role will be already highly concurrent with all other common roles). This type of concurrency may skew the distribution of the concurrency degrees resulting in a long tail, non-symmetric, etc. distribution of roles and thus affect the determination of common access items. Moreover, this approach may suffer from scalability issues when applied to certain access items (e.g., entitlements). This is because the number of certain identity management artifacts (e.g., entitlements) may be a large multiple of the number of certain other identity management artifacts (e.g., roles). For example, a typical medium-size enterprise with 3000 identities may have 1000 roles but may have 100,000 entitlements. Additionally, the results of such an approach (e.g., why certain identity management artifacts were identified as common access items) are hard to explain since the concurrency relationships utilized to make such determinations may not be intuitive to users.

Most importantly, however, as this approach relies on a representation of the identity management structure (e.g., the role structure) of the enterprise itself, it is highly dependent on the quality of that identity management structure (e.g., the role structure) of the enterprise itself. It is typically the case that these portions of the identity management structure are created and maintained by the enterprise (e.g., the roles used by an enterprise may be created and maintained by that enterprise), in many cases in a manual fashion. Such structures are often messy and poorly maintained (e.g., infrequently managed or updated). If the identity management structure (e.g., the role structure) maintained by an enterprise is deficient, it likewise adversely impacts that ability of a method that utilizes such a role structure to accurately or effectively determine common access items from that deficient identity management structure. Moreover, it is less than desirable to offer identity management functionality to an enterprise and then put the onus and responsibility for the quality of such identity management on that very enterprise.

It would be more desirable, therefore, to employ approaches to determining common access items that are both simpler and more accurate. Simpler because identity management data obtained from an enterprise may be used substantially directly to determine common access items without the generation of any representative data structures or the like; and more accurate because embodiments of this approach do not require any separately maintained (e.g. role) structure to work. Instead, embodiments of this approach may require only the identities and corresponding assigned entitlements which are a reflection of the base level data maintained by source systems within the enterprise.

Certain of these embodiments may be based on the intuitive idea that normal data points cluster together while outlier data points with extreme values tend to be isolated. So, finding them from a randomized starting point should be easier (shorter traveling paths on average) than normal points (longer traveling paths on average), length here is measured by how many splits may be made on the variables.

Accordingly, one embodiment for determining common or unique access items may employ a machine learning model (such as an isolation forest model or extended isolation forest model) trained (e.g., directly) based on identity management data obtained from an enterprise, where that machine learning model may be trained to, and utilized for, generating predictive scores for commonality (or uniqueness) for access items. This predictive score can then be used with a threshold to determine common or unique access items in that identity management data or predicting common or unique access items in new, updated or different identity management data. Such a threshold could be identified or based on criteria expressed in terms of certain parameters for identity governance.

Such a model (e.g., a machine learning model) may also be used in association with an (e.g., independent) interpreter. This interpreter may be queried to provide explanations in terms of how much and what type (positive or negative) of influence did certain features have over the model's prediction. Features that resulted in the prediction or determination for a common access item can then be returned to a user.

Initially, embodiments of determining common or unique access items embodiments of the identity management systems disclosed herein may utilize a network graph approach to improve identity governance, including the assessment of roles associated with the identity management data of an enterprise. For example, assessment of the distribution (e.g., commonality or uniqueness) of roles may be determined based on a network graph that includes roles of an enterprise.

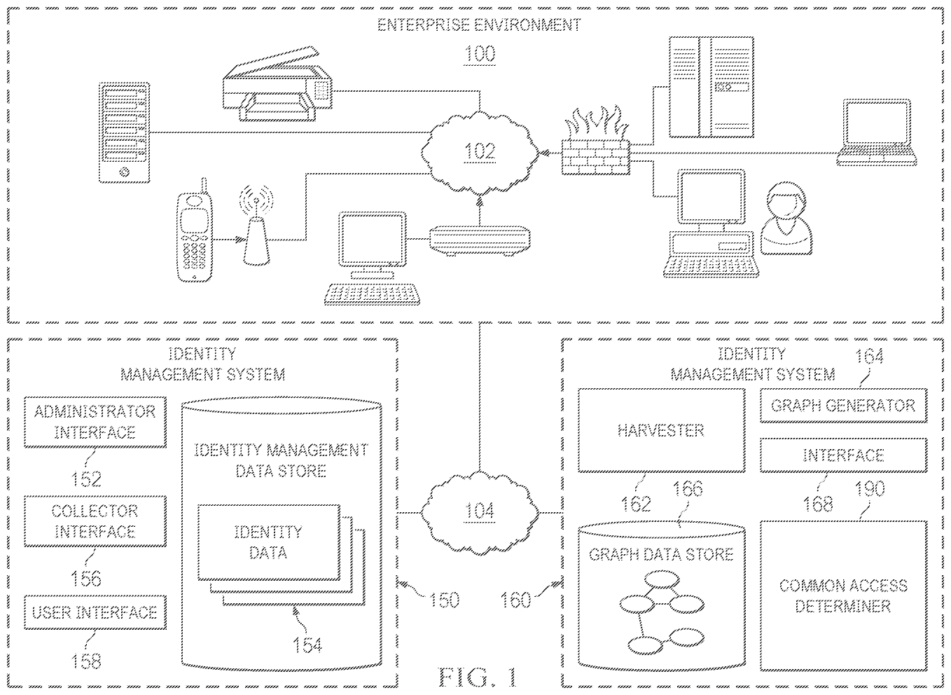

With that in mind, attention is now directed to FIG. 1, where a distributed networked computer environment including one embodiment of an identity management system for determining common or unique access items is depicted. Here, the networked computer environment may include an enterprise computing environment 100. Enterprise environment 100 includes a number of computing devices or applications that may be coupled over a computer network 102 or combination of computer networks, such as the Internet, an intranet, an internet, a Wide Area Network (WAN), a Local Area Network (LAN), a cellular network, a wireless or wired network, or another type of network. Enterprise environment 100 may thus include a number of resources, various resource groups and users associated with an enterprise (for purposes of this disclosure any for profit or non-profit entity or organization). Users may have various roles, job functions (e.g., job titles), responsibilities, etc. to perform within various processes or tasks associated with enterprise environment 100. Users can include employees, supervisors, managers, IT personnel, vendors, suppliers, customers, robotic or application based users, etc. associated with enterprise 100.

Users may access resources of the enterprise environment 100 to perform functions associated with their jobs, obtain information about enterprise 100 and its products, services, and resources, enter or manipulate information regarding the same, monitor activity in enterprise 100, order supplies and services for enterprise 100, manage inventory, generate financial analyses and reports, or generally to perform any task, activity or process related to the enterprise 100. Thus, to accomplish their responsibilities, users may have entitlements to access resources of the enterprise environment 100. These entitlements may give rise to risk of negligent or malicious use of resources.

Specifically, to accomplish different functions, different users may have differing access entitlements to differing resources. Some access entitlements may allow particular users to obtain, enter, manipulate, etc. information in resources which may be relatively innocuous. Some access entitlements may allow particular users to manipulate information in resources of the enterprise 100 which might be relatively sensitive. Some sensitive information can include human resource files, financial records, marketing plans, intellectual property files, etc. Access to sensitive information can allow negligent or malicious activities to harm the enterprise itself. Access risks can thus result from a user having entitlements with which the user can access resources that the particular user should not have access to; or for other reasons. Access risks can also arise from roles in enterprise environment 100 which may shift, change, evolve, etc. leaving entitlements non optimally distributed among various users.

To assist in managing the entitlements assigned to various users and more generally in managing and assessing access risks in enterprise environment 100, an identity management system 150 may be employed. Such an identity management system 150 may allow an administrative or other type of user to define one or more identities, one or more entitlements, or one or more roles, and associate defined identities with entitlements using, for example, an administrator interface 152. The assignment may occur, for example, by directly assigning an entitlement to an identity, or by assigning a role to an identity whereby the collection of entitlements comprising the role are thus associated with the identity. Examples of such identity management systems are Sailpoint's IdentityIQ and IdentityNow products. Note here, that while the identity management system 150 has been depicted in the diagram as separate and distinct from the enterprise environment 100 and coupled to enterprise environment 100 over a computer network 104 (which may the same as, or different than, network 102), it will be realized that such an identity management system 150 may be deployed as part of the enterprise environment 100, remotely from the enterprise environment, as a cloud based application or set of services, or in another configuration.

An identity may thus be almost any physical or virtual thing, place, person or other item that an enterprise would like to define. For example, an identity may be a capacity, groups, processes, physical locations, individual users or humans or almost any other physical or virtual entity, place, person or other item. An entitlement may be an item (e.g., token) that upon granting to a user will allow the user to acquire a certain account or privileged access level that enables the user to perform a certain function within the distributed networked enterprise computer environment 100. Thought of another way, an entitlement may be a specific permission granted within a computer system, such as access to a particular building (based on a user's key badge), access to files and folders, or access to certain parts of websites. Entitlements may also define the actions a user can take against the items they have access to, including, for example, accessing computing systems, applications, file systems, particular data or data items, networks, subnetworks or network locations, etc. Each of these identities may therefore be assigned zero or more entitlements with respect to the distributed networked computer environments.

To facilitate the assignment of these entitlements, enterprise 100 may also be provided with the ability to define roles (e.g., through the identity management system 150). A role within the context of the identity management system 150 may be a collection of entitlements. These roles may be assigned a name or identifiers (e.g., manager 1, engineer level 2, team leader) by an enterprise that designates the type of user or identity that should be assigned such a role. By assigning a role to an identity using the identity management system 150, the identity may be assigned the corresponding collection of entitlements associated with the assigned role.

The identity management system 150 may thus store identity management data 154. The identity management data 154 stored may include a set of entries, each entry corresponding to and including an identity (e.g., alphanumeric identifiers for identities) as defined and managed by the identity management system, a list or vector of entitlements or roles assigned to that identity by the identity management system, and a time stamp at which the identity management data was collected from the identity management system. Other data could also be associated with each identity, including data that may be provided from other systems such as a job title, location or department associated with the identity. The set of entries may also include entries corresponding to roles, where each entry for a role may include the role identifier (e.g., alphanumeric identifier or name for the role) and a list or vector of the entitlements associated with each role. Other data could also be associated with each role, such as a title, location or department associated with the role.

Collectors 156 of the identity management system 150 may thus request or otherwise obtain data from various touchpoint systems within enterprise environment 100. These touchpoint systems may include, for example Active Directory systems, Java Database Connectors within the enterprise 100, Microsoft SQL servers, Azure Active Directory servers, OpenLDAP servers, Oracle Databases, SalesForce applications, ServiceNow applications, SAP applications or Google GSuite.

Accordingly, the collectors 156 of the identity management system 150 may obtain or collect event data from various systems within the enterprise environment 100 and process the event data to associate the event data with the identities defined in the identity management data 154 to evaluate or analyze these events or other data in an identity management context. A user may interact with the identity management system 150 through a user interface 158 to access or manipulate data on identities, roles, entitlements, events or generally perform identity management with respect to enterprise environment 100.

As part of a robust identity management system, it is desirable to analyze the identity management data 154 associated with an enterprise 100. Specifically, it is desirable to group or cluster the identities or entitlements of an enterprise 100 into peer groups such that, for example, the identities in a peer group are similar with respect to the set of entitlements assigned to the identities of that group (e.g., relative to other identities or other groups) or, to determine peer groups of entitlements such that entitlement patterns and assignment may be determined and role mining performed.

Peer grouping of the identities within an enterprise (or viewing the peer groups of identities) may allow, for example, an auditor other person performing a compliance analysis or evaluation to quantitatively and qualitatively assess the effectiveness of any applicable pre-existing policies, or lack thereof, and how strictly they are enforced. Similarly, peer grouping of entitlements may allow roles to be determined from such entitlement groups and outlier entitlements to be identified. This information may, in turn, be utilized to redefine or govern existing roles as defined in the identity management system 150 and allow users of the identity management system 150 greater visibility into the roles of the enterprise 100.

Accordingly, an identity management system 160 may include a harvester 162 and a graph generator 164. The harvester 162 may obtain identity management data from one or more identity management systems 150 associated with enterprise 100. The identity management data may be obtained, for example, as part of a regular collection or harvesting process performed at some regular interval by connecting to, and requesting the identity management data from, the identity management system 150. The identity management data stored may thus include a set of entries, each entry corresponding to and including an identity as defined and managed by the identity management system, a list or vector of entitlements or roles assigned to that identity by the identity management system, and a time stamp at which the identity management data was collected from the identity management system 150. The identity management data may also include a set of entries for roles, each entry corresponding to and including a role as defined and managed by the identity management system 150 and a list or vector of entitlements assigned to that role by the identity management system 150, and a time stamp at which that identity management data was collected from the identity management system 150.

Graph generator 164 may generate a network identity graph from the obtained identity management data. Specifically, in one embodiment, a property (identity) graph may be generated from the identity management data obtained from the enterprise. Each of the identities and entitlements from the most recently obtained identity management data may be determined and a node of the graph created for each identity and entitlement. An edge is constructed between every pair of nodes (e.g., identities) that shares at least one entitlement and between every pair of nodes (e.g., entitlements) that shares at least one identity. Each edge of the graph may also be associated with a similarity weight representing a degree of similarity between the identities of the respective nodes joined by that edge, or between the entitlements of the respective nodes joined by that edge. It will be noted here that while a similarity weight may be utilized on edges between both identity nodes and entitlement nodes, the similarity weight type, determination and value may be determined differently based upon the respective type of node(s) being joined by that weighted edge. Accordingly, the obtained identity management data may be represented by an identity graph (e.g., per enterprise) and stored in graph data store 166.

Once the identity graph is generated by the graph generator 164, the graph may then be pruned to remove edges based on their weighting. Again, the pruning of edges between identity nodes and entitlements nodes may be accomplished in the same, or a different manner. For example, a pruning threshold utilized to prune edges between identity nodes may be different than a pruning threshold utilized to prune edges between entitlement nodes as well as across customers.

The pruned identity graph can then be used to cluster the identities into peer groups of identities or to cluster the entitlements into peer groups of entitlements. This clustering may be accomplished, for example, a community-detection algorithm. This clustering result may also be optimized by the graph generator 164 through the use of a feedback loop to optimize the pruning of the edges until a desired metric for assessing the quality of the peer groups generated exceeds a desired threshold or satisfies certain (e.g., optimization or other) criteria. It will be noted here as well, that while the peer grouping of both identities or entitlements may be determined in embodiments, the peer grouping may be accomplished in the same or different manners for identities and entitlements in different embodiments. For example, the community detection, optimization, feedback loop or quality assessment metric may all be the same or different when clustering the identity or entitlements of the entitlement graph. It will also be noted here, that while identities and entitlements are discussed herein as examples of identity management artifacts that are represented as nodes in the graph, as discussed above, other identity management artifacts (e.g., roles, groups, etc.) may also be represented as nodes in the identity graph, and may be similar clustered or grouped into peer groups.

More generally, then, the pruning and clustering of the identity nodes of the identity graph may be performed separately from the pruning and clustering of the entitlement nodes of the identity graph. Accordingly, the property graph may comprise at least two subgraphs, the identities subgraph comprising at least the identity nodes and edges between these identity nodes and the entitlement subgraph comprising at least the entitlement nodes and edges between those entitlement nodes. Once the peer groups of identities or entitlements are determined, the peer groups can then be stored (e.g., separately or in the property graph itself) and used by the identity management system 160. For example, each peer group of identities (also referred to herein as an identity group) may be assigned a peer group identifier and the peer group identifier associated with each identity assigned to the peer group by storing the peer group identifier in association with the node in the graph representing that identity. Similarly, each peer group of entitlements (e.g., also referred to herein as an entitlement group) may be assigned a peer group identifier and the peer group identifier associated with each entitlement assigned to the peer group by storing the peer group identifier in association with the node in the graph representing that entitlement.

An interface 168 of the identity management system 160 may use the identity graph in the graph data store 166 or associated peer groups to present one or more interfaces which may be used for risk assessment, as will be discussed. For example, an interface 168 may present a visual representation of the graph, the identities, entitlements, or the peer groups in the identity graph to a user of the identity management system 160 associated with enterprise 100 to assist in compliance or certification assessments or evaluation of the identities, entitlements or roles as currently used by the enterprise (e.g., as represented in identity management data 154 of identity management system 150).

Before moving on, it will be noted here that while identity management system 160 and identity management system 150 have been depicted separately for purposes of explanation and illustration, it will be apparent that the functionality of identity management systems 150, 160 may be combined into a single or a plurality of identity management system as is desired for a particular embodiment and the depiction and separation of the identity management systems and their respective functionality has been depicted separately solely for purposes of ease of depiction and description.

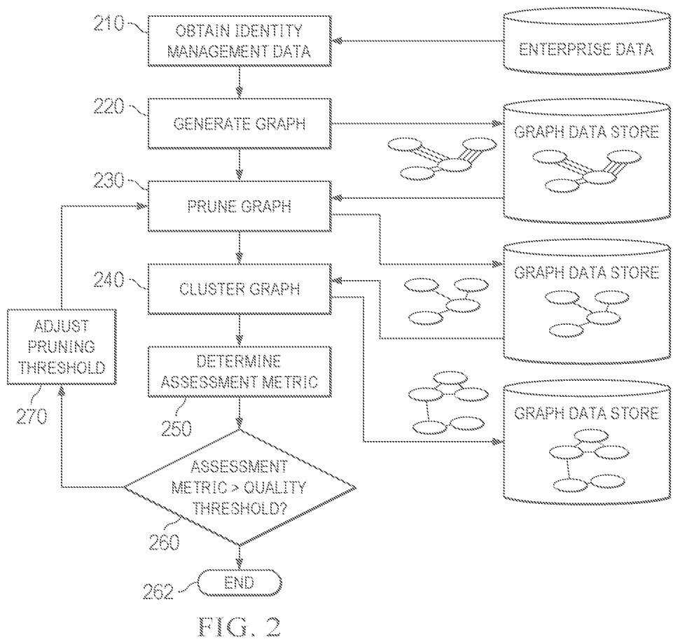

Turning now to FIG. 2, a flow diagram for one embodiment of a method for determining peer groups of identities using a graph database is depicted. Embodiments of such a method may be employed by graph generators of identity management systems to generate identity graphs and associated peer groups from identity management data, as discussed above. It will be noted here, that while this embodiment is described in association with the determination of peer groups of identities in the identity graph, similar embodiments may be applied to entitlement nodes and associated similarity relationships of an identity graph to determine peer groups of entitlements in such an identity graph.

Initially, at step 210, identity management data may be obtained. As discussed, in one embodiment, this identity management data may be obtained from one or more identity management systems that are deployed in association with an enterprise's distributed computing environment. Thus, the identity management data may be obtained, for example, as part of a regular collection or harvesting process performed at some regular interval by connecting to, requesting the identity management data from, an identity management system. The identity management data may also be obtained on a one-time or user initiated basis.

As will be understood, the gathering of identity management data and determination of peer groups can be implemented on a regular, semi-regular or repeated basis, and thus may be implemented dynamically in time. Accordingly, as the data is obtained, it may be stored as a time-stamped snapshot. The identity management data stored may thus include a set of entries, each entry corresponding to and including an identity (e.g., alphanumeric identifiers for identities) as defined and managed by the identity management system, a list or vector of entitlements assigned to that identity by the identity management system, and a time stamp at which the identity management data was collected from the identity management system. Other data could also be associated with each identity, including data that may be provided from an identity management system such as a title, location or department associated with the identity. The collection of entries or identities associated with the same time stamp can thus be thought of as a snapshot from that time of the identities and entitlements of the enterprise computing environment as managed by the identity management system.

As an example of identity management data that may be obtained from an identity management system, the following is one example of a Javascript Object Notation (JSON) object that may relate to an identity:

```
{
  “attributes”: {
    “Department”: “Finance”,
    “costcenter”: “[R01e, L03]”,
    “displayName”: “Catherine Simmons”,
    “email”: “Catherine.Simmons@demoexample.com”,
    “empId”: “1b2c3d”,
    “firstname”: “Catherine”,
    “inactive”: “false”,
    “jobtitle”: “Treasury Analyst”,
    “lastname”: “Simmons”,
    “location”: “London”,
    “manager”: “Amanda.Ross”,
    “region”: “Europe”,
    “riskScore”: 528,
    “startDate”: “12/31/2016 00:00:00AM UTC”,
    “nativeIdentity_source_2”: “source_2”,
    “awesome_attribute_source_1”: “source_1”,
    “twin_attribute_a” : “twin a”,
    “twin_attribute_b” : “twin b”,
    “twin_attribute_c” : “twin c”
  {
  “id”: “2c9084ee5a8de328015a8de370100082”,
  “integration_id”: “iiq”,
  “customer_id”: “ida-bali”,
  “meta”: {
    “created”: “2017-03-02T07:19:37.233Z”,
    “modified”: “2017-03-02T07:24:12.024Z”
  },
  “name”: “Catherine.Simmons”,
  “refs”: {
    “accounts”: {
      “id”: [
        “2c9084ee5a8de328015a8de370110083”
      ],
      “type”: “account”
    },
    “entitlements”: {
      “id”: [
        “2c9084ee5a8de328015a8de449060e54”,
        “2c9084ee5a8de328015a8de449060e55”
      ],
      “type”: “entitlement”
    },
    “manager”: {
      “id”: [
        “2c9084ee5a8de022015a8de0c52b031d”
      ],
      “type”: “identity”
    }
  },
  “type”: “identity”
}
```

As another example of identity management data that may be obtained from an identity management system, the following is one example of a JSON object that may relate to an entitlement:

```
{
  “integration_id”: “bd992e37-bbe7-45ae-bbbf-c97a59194cbc”,
  “refs”: {
    “application”: {
      “id”: [
        “2c948083616ca13a01616ca1d4aa0301”
      ],
      “type”: “application”
    }
  },
  “meta”: {
    “created”: “2018-02-06T19:40:08.005Z”,
    “modified”: “2018-02-06T19:40:08.018Z”
  },
  “name”: “Domain Administrators”,
  “attributes”: {
    “description”: “Domain Administrators group on Active Directory”,
    “attribute”: “memberOf”,
    “aggregated”: true,
    “requestable”: true,
    “type”: “group”,
    “value”: “cn=Domain Administrators,dc=domain,dc=local”
  },
  “id”: “2c948083616ca13a01616ca1f1c50377”,
  “type”: “entitlement”,
  “customer_id”: “3a60b474-4f43-4523-83d1-eb0fd571828f”
}
```

As another example of identity management data that may be obtained from an identity management system, the following is one example of a JSON object that may relate to a role:

```
{
“id”: “id”,
“name”: “name”,
“description”:
“description”,
“modified”: “2018-09-
07T17:49:33.667Z”, “created”:
“2018-09-07T17:49:33.667Z”,
“enabled”: true,
“requestable”: true,
“tags”: [
{
      “id”: “2c9084ee5a8ad545345345a8de370110083”
        “name” : “SOD-SOX”,
            “type”: “TAG”
      },
{
      “id”: “2c9084ee5a8ad545345345a8de370122093”
        “name” : “PrivilegedAccess”,
            “type”: “TAG”
      },
]
“accessProfiles”:
[
  {
          “id”: “accessProfileId”,
    “name”: “accessProfileName”
}
],
“accessProfileCount”:
1, “owner”: {
“name”: “displayName”,
“id”: “ownerId”
},
“synced”: “2018-09-07T17:49:33.667Z”
}
```

At step 220 a network identity graph may be generated from the identity management data obtained from the enterprise. Specifically, each of the identities and entitlements from the most recent snapshot of identity management data may be obtained and a node of the graph created for each identity and entitlement. An edge is constructed between every pair of identity nodes (e.g., identities) that share at least one entitlement (e.g., an edge connects two identity nodes if and only if they have at least one entitlement in common). An edge may also be constructed between every pair of entitlement nodes (e.g., entitlements) that shares at least one identity (e.g., an edge connects two entitlement nodes if and only if they have at least one identity in common).

Each edge of the graph joining identity nodes or entitlement nodes may be associated with a similarity weight representing a degree of similarity between the identities or entitlements of the respective nodes joined by that edge. For identity nodes, the similarity weight of an edge joining the two identity nodes may be generated based on the number of entitlements shared between the two joined nodes. As but one example, the similarity weight could be based on a count of the similarity (e.g., overlap or intersection of entitlements) between the two identities divided by the union of entitlements. Similarly, for identity nodes, the similarity weight of an edge joining the two entitlement nodes may be generated based on the number of identities shared between the two joined nodes. As but one example, the similarity weight could be based on a count of the similarity (e.g., overlap or intersection of identities) between the two entitlements divided by the union of identities. For instance the similarity could be defined as the ratio between a number of identities having both entitlements joined by the edge to the number of identities that have either one (e.g., including both) of the two entitlements.

In one embodiment, the edges are weighted via a proper similarity function (e.g., Jaccard similarity). In one embodiment, a dissimilarity measure, of entitlement or identity binary vectors, d, may be chosen, then the induced similarity, 1−d(x,y), may be used to assign a similarity weight to the edge joining the nodes, x,y. Other methods for determining a similarity weight between two nodes are possible and are fully contemplated herein. Moreover, it will be noted here that while a similarity weight may be utilized on edges between both identity nodes and entitlement nodes, the similarity weight type, determination and value may be determined differently based upon the respective type of node(s) being joined by that weighted edge.

In one specific embodiment, a symmetric matrix for identities (e.g., an identity adjacency matrix) may be determined with each of the identities along each axis of the matrix. The diagonal of the matrix may be all 0s while the rest of values are the similarity weights determined between the two (identity) nodes on the axes corresponding to the value. In this manner, this symmetric matrix may be provided to a graph constructor which translates the identities on the axes and the similarity values of the matrix into graph store commands to construct the identity graph. Similarly, a symmetric matrix for entitlements (e.g., an entitlement adjacency matrix) may be determined with each of the entitlements along each axis of the matrix. The diagonal of the matrix may be all 0s while the rest of values are the similarity weights determined between the two (entitlement) nodes on the axes corresponding to the value. In this manner, this symmetric matrix may be provided to a graph constructor which translates the entitlement on the axes and the similarity values of the matrix into graph store commands to construct the identity graph.

Accordingly, the identity management data may be faithfully represented by a graph, with k types of entities (nodes/vertices, e.g., identity-id, title, location, entitlement, etc.) and stored in a graph data store. It will be noted that graph data store may be stored in any suitable format and according to any suitable storage, including, for example, a graph store such a Neo4j, a triple store, a relational database, etc. Access and queries to this graph data store may thus be accomplished using an associated access or query language (e.g., such as Cypher in the case where the Neo4j graph store is utilized).

Once the identity graph is generated, the graph may then be pruned at step 230. Here, the identity graph may be pruned to remove weak edges (e.g., those edges whose similarity weight may fall below a pruning threshold). The pruning of the graph is associated with the locality aspect of identity governance, where an identity's access entitlements should not be directly impacted, if at all, by another identity with strongly dissimilar entitlement pattern (e.g., a weak connecting edge) or that determined should be based on strong commonality or popularity of entitlements within an identity grouping. Accordingly, the removal of such edges may not dramatically alter the global topology of the identity graph. An initial pruning threshold may be initially set or determined (e.g., as 50% similarity or the like) and may be substantially optimized or otherwise adjusted at a later point. As another example, a histogram of similarity weights may be constructed and a similarity weight corresponding to a gap in the similarity weights of the histogram may be chosen as an initial pruning threshold. Again, the pruning of edges between identity nodes and entitlements nodes may be accomplished in the same, or a different manner. For example, the pruning threshold utilized to prune edges between identity nodes may be different than a pruning threshold utilized to prune edges between entitlement nodes.

The pruned identity graph can then be used to cluster the identities or entitlements into peer groups of identities or peer groups of entitlements at step 240. Within this graph approach, a representation of a peer group of identities could be represented by a maximal clique, where every identity is strongly connected (e.g., similar) to every other identity within the identity peer group, and consequently, members of the clique all share a relatively large, and hence dominant, common core of entitlements. A representation of an entitlement peer group could be represented by a maximal clique, where every entitlement is strongly connected (e.g., similar) to every other entitlement within the peer group, and consequently, members of the clique all share a relatively large, and hence dominant, common core of identities. The problem of finding all maximal cliques of a graph may, however, be a memory and computationally intensive problem. Most clique related problems in graph theory are hard and some of them are even NP-complete, requiring exponential time to finish as graphs with exponentially many maximal cliques may exist.

Accordingly, in one embodiment a community-detection algorithm may be utilized for peer grouping the identities or entitlements of the identity graph to speed the determination of the peer groups, reduce computational overhead and conserve memory, among other advantages. A plethora of applicable and performant community-detection and graph clustering algorithms may be utilized according to certain embodiments. Some of these algorithms are specifically targeted to large graphs, which can be loosely described as graphs with at least tens or hundreds (or more) of thousands of nodes and millions of edges. Such graph community-detection algorithms may include, for example, Louvain, Leiden, Fast-greedy, Label Propagation or Stochastic Block Modeling. Other graph community detection algorithms may be utilized and are fully contemplated herein.

In certain embodiments, a clustering result may be optimized through the use of a feedback loop, as discussed below. As such, in one embodiment it may be desirable to utilize a community-detection algorithm for determination of the peer groups that may provide a straightforward determination of a peer group assessment metric for a quality assessment of determined peer groups or the identity graph. Accordingly, a community-detection algorithm that may be based on, or allow a determination of, a graph based metric (e.g., modularity, evolving topology, connected components, centrality measures (e.g., betweenness, closeness, community overlap measures such as NMI or Omega indices)) that may be used as a peer group assessment metric may be utilized.

Specifically, in one embodiment, the Louvain algorithm may be utilized as a community-detection algorithm and modularity may be used as a peer assessment metric. The Louvain algorithm may not only be a scalable algorithm that can handle, and be efficient on, large graphs; but additionally the Louvain algorithm may be based on modularity or be modularity optimized. Modularity is a scalar that can be determined for a graph or groups or subgraphs thereof. This modularity reflects a likelihood of the clusters generated (e.g., by the algorithm) to not have been generated by random chance. A high modularity value, (e.g., positive and away from 0) may indicate that the clustering result is unlikely to be a product of chance. This modularity can thus be used as a peer group assessment metric.

Moreover, in addition to the application of a peer group assessment metric to optimize the peer groups or identity graphs determined using such community-detection algorithms, an identity management system may employ alerts based on these peer group assessment metrics. For example, an alert to a user may be based on an alert threshold (e.g., if the peer group assessment metric drops below or above a certain threshold) or if any changes over a certain threshold occur with respect to the peer group assessment metric. For example, setting an empirical low threshold for modularity, with combined user alerts, could serve as a warning for deteriorating quality of peer groups or the identity graph. This could be due to input data having been corrupted at some point in the pipeline, or in other cases, that the access entitlement process for the particular enterprise is extremely lacking due discipline. Regardless of the underlying cause, such an early warning system may be valuable to stop the propagation of questionable data quality in the peer group assessment and determination process and more generally to identity management goals within the enterprise.

In many cases, the community-detection or other clustering algorithm utilized in an embodiment may fall under the umbrella of what is usually termed unsupervised machine-learning. Results of these types of unsupervised learning algorithms may leave some room for interpretation, and do not, necessarily or inherently, provide outputs that are optimized when the domain or context in which they are being applied are taken into account. Consequently, to mitigate some of these issues and to optimize the use of the peer groups and identity graphs in an identity governance context, embodiments of identity management systems employing such peer groups of identities or entitlements using an identity graph may allow some degree of user configuration, where at a least a portion of the user configuration may be applied in the graph determination, peer-grouping or optimization of such peer group determination.

This configurability may allow the user of an identity management system to, for example, impose some constraints or set up certain configuration parameters for the community-detection (or other peer grouping) algorithm in order to enhance the clustering results for a particular use-case or application. A few non-exhaustive examples of user configuration are thus presented. A user may have a strongly defined concept of what constitutes a ‘peer’. This may entail that the user's specification of what continues a peer may be used to derive a pruning threshold with statistical methods (e.g., rather than relying on modularity).

As another example of configurability, a user may elect to opt for a hierarchical clustering output, or that peer groups should have certain average size, which may entail to allowing for several consecutive iterations of the community-detection algorithm to be performed (as will be explained in more detail herein). A user may also elect to run the peer grouping per certain portions of the identities or entitlements, versus running it for all identities or entitlements. The filtered population of identities or entitlements may be specified in terms of geographic location, business role, business unit, etc. Similarly, a user may elect to filter the outputs of the community-detection algorithm in terms of certain identity or entitlement attributes, e.g., identity role, identity title, identity location, etc. The results might then be quantitatively and qualitatively contrasted against existing governance policies to measure, assess and certify compliance with these policies.

Generally then, a user may elect to utilize the peer grouping feature in combination with other tools of identity governance, in order to gain more insight into the quality of identity governance policy enforcement within the business. This entails that peer grouping should be configurable and flexible enough to allow it to be paired with other (e.g., third-party) identity management tools. Accordingly, certain restrictions may be imposed on the identity graph's or peer group's size, format, level of detail, etc.

In any event, once the peer groups of identities or entitlements of the pruned identity graph are used to cluster the identities into peer groups of identities at step 240 the determined peer groups can then be stored (e.g., separately or in the identity graph itself) and used by the identity management system. For example, each peer group (e.g., or identities or entitlements) may be assigned a peer group identifier and the peer group identifier associated with each identity assigned to the peer group by storing the peer group identifier in association with the node in the graph representing that identity or entitlement.

As an example of use a visual representation of the graph, the identities, entitlements or the peer groups in the identity graph may be presented to a user of the identity management to assist in compliance or certification assessments or evaluation of the identities and entitlements as currently used by the enterprise. In principle, strictly enforced pre-existing governance policies should ensure that identities with strongly similar access privileges are strongly similar (e.g., are in the same peer group). The presentation of such peer groups may thus, for example, allow an auditor or compliance assessor to quantitatively and qualitatively assess the effectiveness of any applicable pre-existing policies, or lack thereof, and how strictly they are enforced.

During such collection, graph determination and peer grouping steps, in certain embodiments, a number of efficiencies may be implemented to speed the collection process, reduce the amount data that must be stored and to reduce the computer processing overhead and computing cycles associated with such data collection, graph determination and peer grouping of such data. Specifically, in one embodiment, a delta change assessment may be performed when identity management data is collected or peer groups are determined in a current time period. More specifically, if identity management data was collected in a previous time period, or a previous peer grouping has been performed on identities or entitlements of a previously created identity graph, an assessment can be made (e.g., by a data querying script or process) of the difference (or delta) between the set of identities or entitlements corresponding to the most recent previous snapshot and the set of identities or entitlements obtained in the current time period. This assessment may comprise a determination of how many changes to the identities, associated entitlements or other attributes have occurred between the time of the previous snapshot and the current snapshot (e.g., the most recent identity management data collected in the current time period).

An assessment may also be made of the difference between the peer groups determined from the most recent previous snapshot and the peer groups obtained in the current time period. This assessment may comprise a determination of how many identities or entitlements are associated with different peer groups (e.g., relative to the peer grouping of identities or entitlements determined from the previous most recent snapshot), changes to the identities or entitlements or how many new identities are associated with an established (or new) peer group.

If there are no determined changes, or the changes are below some threshold number, or are few, local, or insignificant to a large majority of existing peer groups, then no action is needed other than updating the affected identities or entitlements in the data of the previous snapshot or the identity graph. New entries in the entries comprising the current snapshot of identities or entitlements may be created for any newly identified identities or entitlements. Additionally, nodes in the graph corresponding to new identities or entitlements can be appended to an appropriate peer group based on how similar this new identity is to existing peer groups, (e.g., assign the new identity the peer group of the same department/title).

If the differences (e.g., number of changes, new identities, different peer group assignments, etc.) are non-trivial, affecting a multitude of identities across peer groups, then a new peer grouping process may occur on the newly refreshed data. In such cases, a detection algorithm may be used to evolve, and persist, previously determined peer groups into their recent counterparts. This can be done by monitoring certain ‘marker’ identities, e.g., influencers, or identities with high centrality values and/or high degree of connections, in both versions of peer groups. Utilizing a majority vote approach, it can be determined how previous peer groups evolve into newer ones. Expected updated versions of the previous peer group, include splitting, merging, growth, shrinkage. Newer split peer groups may, for example, inherit the ‘old’ peer group identifiers.

Embodiments of such a delta detection and updating mechanisms may have the further advantage of allowing the quality and stability of each peer group to be monitored by an identity management system via tracking the peer groups or identity graph, the changes thereto, or their evolution over time. By actively monitoring and assessing the degree of these changes between two or more consecutive versions of a peer group or identity graph, deteriorating quality issues may be detected as they arise or manifest in the identity graph or peer groups determined therefrom. Similarly, using the identity graphs, peer groups or peer group assessment metrics determined therefrom, a graph evolution model may be built in certain embodiments, (e.g., based on epidemiology susceptible, infected and recovered type models). Comparing the observed evolution of identities, entitlements or peer groups versus theoretical predictions may provide another tool to warn users of an identity management system against rapid or extreme changes that may negatively impact the quality of peer groups or identity management more generally.

Again, once the peer groups of identities or entitlements are determined from the pruned identity graph and stored (at step 240), a peer group assessment metric may be determined based on the identity graph or the determined peer groups at step 250. As discussed, this peer group assessment metric may be determined separately based on the peer groups or identity graph determined, or may be metric utilized by a community-detection algorithm, such that the peer group assessment metric may be determined as part of the peer group determination process. In certain embodiments then, the application of a community-detection algorithm may result in such a peer group assessment metric (e.g., modularity, evolving topology, connected components, centrality measures e.g., betweenness, closeness, community overlap measures (e.g., NMI, Omega indices)) that may be used as a peer group assessment metric may be utilized.

For example, as discussed above the Louvain algorithm may be a graph-based modularity optimized community-detection algorithm. Thus, a modularity associated with the determined peer groups may result from the determination of the peer group using the Louvain algorithm. Modularity is a scalar that can be determined for a graph or groups or subgraphs thereof and reflects a likelihood of the clusters generated (e.g., by the algorithm) to not have been generated by random chance. A high modularity value, (e.g., positive and away from 0) may indicate that the clustering result is unlikely to be a product of chance. This modularity can be used as a peer group assessment metric in one embodiment.

Accordingly, in certain embodiments, the clustering of identities or entitlements into peer groups may be optimized based on this peer group assessment metric. Specifically, a feedback loop may be utilized to determine the optimal pruning threshold. The optimization loop may serve to substantially increase or maximize the quality of the graph clustering, with respect to certain proper metrics (e.g., graph modularity or other peer group assessment metric). Additional domain-specific, per enterprise, criteria may be utilized in this step in certain embodiments in order to render clustering results that accurately reflect certain requirements to better serve a particular enterprise or use of the peer groups or identity graph.

For instance, in one embodiment if the peer group assessment metric is above (or below) a quality threshold at step 260 the determination of peer groups of identities or entitlements for the obtained in the current snapshot may end at step 262. The determined peer groups of identities or entitlements can then be stored (e.g., separately or in the identity graph) and used by the identity management system.

However, if the peer group assessment metric is below (or above) a quality threshold at step 260 a feedback loop may be instituted whereby the pruning threshold is adjusted by some amount at step 270 (up or down) and the originally determined identity graph is again pruned based on the adjusted pruning threshold (or the previously pruned identity graph may be further pruned) at step 230. The adjustment of the pruning threshold may be based on a wide variety of criteria in various embodiments and may be adjusted by a fixed or differing amount in every iteration through the feedback loop. Additionally, in some embodiments, various machine learning techniques (e.g., unsupervised machine learning techniques such as k-means, method of moments, neural networks, etc.) may be used to determine an amount to adjust the pruning threshold or a value for the adjusted pruning threshold). This newly pruned identity graph can then be clustered into new peer groups of identities or entitlements at step 240 and a peer group assessment metric determined at step 250 based on the newly pruned identity graph or the newly determined peer groups.

If this new peer assessment metric is now above (or below) the quality threshold at step 260 the feedback loop may be stopped and the determination of peer groups of identities or entitlements for the data obtained in the current snapshot may end at step 262. These peer groups of identities or entitlements can then be stored (e.g., separately or in the identity graph) and used by the identity management system.

Otherwise, the feedback loop may continue by again adjusting the pruning threshold further at step 270 (e.g., further up or further down relative to the previous iteration of the feedback loop), re-pruning the identity graph based on the adjusted pruning threshold at step 230, clustering this newly pruned graph at step 240, determining another peer group assessment metric at step 250 and comparing this metric to the quality threshold at step 260. In this manner, the feedback loop of adjustment of the pruning threshold, re-pruning the graph and re-clustering the identity graph into peer groups may be repeated until the peer group assessment metric reaches a desired threshold. Moreover, by tailoring the peer group assessment metric and quality threshold to include or reflect domain or enterprise specific criteria (e.g., which may be specified by a user of the identity management system), the clustering results (e.g., the peer groups resulting from the clustering) may more accurately reflect particular requirements or the needs of a particular enterprise or be better tailored to a particular use.

Once the feedback loop is ended (step 262) the determined peer groups of identities or entitlements can then be stored (e.g., separately or in the identity graph) and used by the identity management system. For example, a visual representation of the graph may be presented to a user of the identity management to assist in compliance or certification assessments or evaluation of the identities and entitlements as currently used by the enterprise.

It will be noted here as well, that while the peer grouping of both identities or entitlements may be determined in embodiments, the peer grouping may be accomplished in the same or different manners for identities and entitlements in different embodiments. For example, the community detection, optimization, feedback loop or quality assessment metric (e.g., steps 230, 240, 250, 260 and 270) may all be performed the same or differently when clustering the identity or entitlements of the entitlement graph. More generally, then, the pruning and clustering of the identity nodes of the identity graph may be performed separately from the pruning and clustering of the entitlement nodes of the identity graph. In certain embodiments, for example, the pruning and clustering (e.g., steps 230, 240, 250, 260 and 270) of the identity nodes of the identity graph may be performed as a separate process from the pruning and clustering (e.g., steps 230, 240, 250, 260 and 270) of the entitlement nodes of the identity graph. Accordingly, the identity graph may be comprised of at least two subgraphs, the identities subgraph comprising at least the identity nodes and edges between these identity nodes and the entitlement subgraph comprising at least the entitlement nodes and edges between those entitlement nodes.

It may now be helpful to look at such visual depictions and presentations of identity graphs or interfaces that may be created or presented based on such identity graphs. It will be apparent that these depictions and interfaces are but example of depictions and interfaces that may presented or utilized, and that almost any type of presentation, depiction or interface based on the identities, entitlements, peer groups or other associated data discussed may be utilized in association with the embodiments of identity management systems disclosed herein.

As discussed, embodiments of the identity management systems as disclosed may create, maintain or utilize network identity graphs. These identity graphs may include a graph comprised of nodes and edges, where the nodes may include identity management nodes representing, for example, an identity, entitlement or peer group, and the edges may include relationships between these identity management nodes. The relationships represented by the edges of the identity graph may be assigned weights or scores indicating a degree of similarity between the nodes related by a relationship, including, for example, the similarity between two nodes representing an identity or two nodes representing an entitlement, as discussed. Additionally, the relationships may be directional, such that they may be traversed only in a single direction, or have different weightings depending on the direction in which the relationship is traversed or the nodes related. Embodiments of such an identity graph can thus be searched (or navigated) to determine data associated with one or more nodes. Moreover, the similarity between, for example, the identities or entitlements may be determined using the weights of the relationships in the identity graph.

Specifically, in certain embodiments, a property graph may be thought of as a graph comprising a number of interrelated nodes. These nodes may include nodes that may have labels defining the type of the node (e.g., the type of “thing” or entity that the node represents, such as an identity, entitlement or peer group) and properties that define the attributes or data of that node. For example, the labels of the nodes of an identity graph may include “Identity”, “Entitlement” or “PeerGroup”. Properties of a node may include, “id”, “company”, “dept”, “title”, “location”, “source” “size”, “clique”, “mean_similarity”, or the like.

The nodes of the property graph may be interrelated using relationships that form the edges of the graph. A relationship may connect two nodes in a directional manner. These relationships may also have a label that defines the type of relationship and properties that define the attributes or data of that relationship. These properties may include an identification of the nodes related by the relationship, an identification of the directionality of the relationship or a weight or degree of affinity for the relationship between the two nodes. For example, the labels of the relationships of an identity graph may include “Similarity” or “SIM”, “Has_Entitlement” or “HAS_ENT”, “Belongs_To_PeerGroup” or “BELONGS_TO_PG”, or the like.

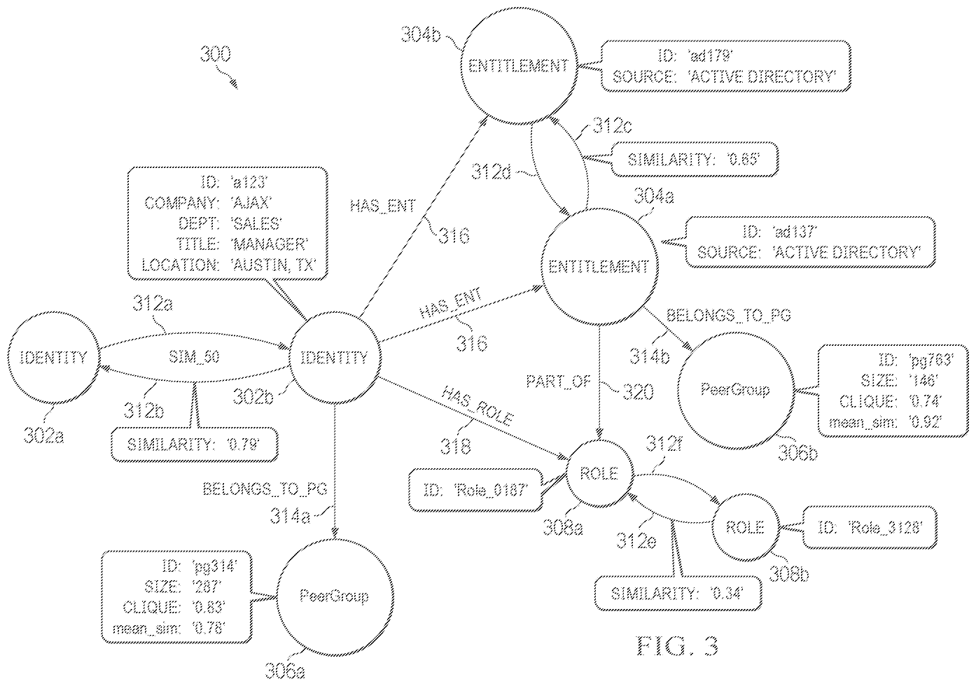

Referring then to FIG. 3, a graphical depiction of a portion of an example identity graph 300 is depicted. Here, nodes are represented by circles and relationships are represented by the directional arrows between the nodes. Such an identity graph 300 may represent identities, entitlements or peer groups, their association, and the degree of similarity between identities represented by the nodes. Thus, for example, the identity nodes 302a, 302b have the label “Identity” indicating they are identity nodes. Identity node 302b is shown as being associated with a set of properties that define the attributes or data of that identity node 302b, including here that the “id” of identity node 302b is “a123”, the “company” of identity node 302b is “Ajax”, the “dept” of identity node 302b is “Sales”, the “title” of identity node 302b is “Manager”, and the “location” of identity node 302b is “Austin, TX”.

These identity nodes 302 of the identity graph 300 are joined by edges formed by directed relationships 312a, 312b. Directed relationship 312a may represent that the identity of identity node 302a is similar to (represented by the labeled “SIM” relationship 312a) the identity represented by identity node 302b. Similarly, directed relationship 312b may represent that the identity of identity node 302b is similar to (represented by the labeled “SIM” relationship 312b) the identity represented by identity node 302a. Here, relationship 312b has been assigned a similarity weight of 0.79. Notice that while these relationships 312a, 312b are depicted as individual directional relationships, such a similar relationship may be a single bidirectional relationship assigned a single similarity weight.

Entitlement nodes 304a and 304b have the label “Entitlement” indicating that they are entitlement nodes. Entitlement node 304a is shown as being associated with a set of properties that define the attributes or data of that entitlement node 304a, including here that the “id” of entitlement node 304 is “ad137”, and the “source” of entitlement node 304a is “Active Directory”. Entitlement node 304b is shown as being associated with a set of properties that define the attributes or data of that entitlement node 304b, including here that the “id” of entitlement node 304b is “ad179”, and the “source” of entitlement node 304a is “Active Directory”.

These entitlement nodes 304 of the identity graph 300 are joined by edges formed by directed relationships 312c, 312d. Directed relationship 312c may represent that the entitlement node 304a is similar to (represented by the labeled “SIM” relationship 312c) the entitlement represented by entitlement node 304b. Similarly, directed relationship 312d may represent that the entitlement of entitlement node 304b is similar to (represented by the labeled “SIM” relationship 312d) the entitlement represented by entitlement node 304a. Here, relationship 312c has been assigned a similarity weight of 0.65. Notice that while these relationships 312c, 312d are depicted as individual directional relationships, such a similar relationship may be a single bidirectional relationship assigned a single similarity weight.

Identity node 302b and entitlement nodes 304a, 304b of the identity graph 300 are joined by edges formed by directed relationships 316, 316. Directed relationships 316 may represent that the identity of identity node 302b has (represented by the labeled “HAS_ENT” relationships 316) the entitlements represented by entitlement nodes 304a, 304b.

Peer group node 306a has the label “PeerGroup” indicating that it is a peer group node. Peer group node 306a is shown as being associated with a set of properties that define the attributes or data of that peer group node 306a, including here that the “id” of peer group node 306a is “pg314”, the “size” of peer group node 306a is “287”, the “clique” of peer group node 306a is “0.83” and the “mean_sim” or mean similarity value of peer group node 306a is “0.78”. Identity node 302b and peer group node 306a of the identity graph 300 are joined by an edge formed by directed relationship 314a. Directed relationship 314a may represent that the identity of identity node 302b belongs to (represented by the labeled “BELONGS_TO_PG” relationship 314a) the peer group represented by peer group node 306a.

Peer group node 306b has the label “PeerGroup” indicating that it is a peer group node. Peer group node 306b is shown as being associated with a set of properties that define the attributes or data of that peer group node 306b, including here that the “id” of peer group node 306b is “pg763”, the “size” of peer group node 306b is “146”, the “clique” of peer group node 306b is “0.74” and the “mean_sim” or mean similarity value of peer group node 306b is “0.92”. Entitlement node 304a and peer group node 306b of the identity graph 300 are joined by an edge formed by directed relationship 314b. Directed relationship 314b may represent that the identity of entitlement node 304a belongs to (represented by the labeled “BELONGS_TO_PG” relationship 314b) the peer group represented by peer group node 306b.

Entitlement nodes 308a, 308b have the label “Role” indicating that they are Role nodes. Role node 308a is shown as being associated with a set of properties that define the attributes or data of that Role node 308a, including here that the “id” of entitlement node 308a is “Role_0187”. Role node 308b is shown as being associated with a set of properties that define the attributes or data of that role node 308b, including here that the “id” of role node 308b is “Role_3128”. Directed relationship 318 may represent that the identity of identity node 302b has (represented by the labeled “HAS_ROLE” relationship 318) the role represented by role node 308a. Directed relationship 320 may represent that the entitlement of entitlement node 304a is a part of or included in (represented by the labeled “PART_OF” relationship 320) the role represented by role node 308a.

These role nodes 308 of the identity graph 300 are joined by edges formed by directed relationships 312e, 312f. Directed relationship 312e may represent that the role represented by role node 304a is similar to the role represented by role node 304b. Similarly, directed relationship 312f may represent that the role represented by role node 308b is similar to the role represented by role node 308a. Here, relationship 312e has been assigned a similarity weight of 0.34. Again, notice that while these relationships 312e, 312f are depicted as individual directional relationships, such a similar relationship may be a single bidirectional relationship assigned a single similarity weight.

Referring back now to FIG. 1, in certain embodiments an identity graph created by identity management system 160 may be utilized to determine common or unique access items. In particular, identity management system 160 may include common access determiner 190 adapted to utilize identity graph 192 for enterprise 100 stored in graph data store 166 to determine one or more common or unique identity management artifacts (i.e., common or unique access items) of enterprise 100. Thus, common access determiner 190 may be adapted to determine concurrency between each pair of identity management artifacts (e.g., roles) being evaluated (e.g., a set of access items in the enterprise, a set of access items in a group or division of an enterprise such as a location, or some other definition used for segmenting or grouping access items). This concurrency is a measure of the number of identities shared between the pair of identity management artifacts (e.g., roles). Such concurrency may be determined based on identity management graph 192. In one embodiment, the concurrency may be the Jaccard similarity of the (e.g., pair of) identity management artifacts (e.g., roles) based on the identities which have been assigned those identity management artifacts (e.g., the identities that share that role).

Common access determiner 190 is also adapted to determine concurrency degree for each identity management artifact (e.g., role) based on the concurrency between that identity management artifact and each other identity management artifact of the group of identity management artifacts being evaluated. Specifically, the (e.g., role) concurrency degree for an identity management artifact (e.g., role) may be the number of other identity management artifacts that have a concurrency with that identity management artifact that is above some threshold (e.g., which may be user or algorithmically determined, may be adjustable, etc.).

Using the concurrency degrees determined for each identity management artifact, common access determiner 190 may determine the distribution of identity management artifact based on the concurrency degrees determined for the identity management artifact. Common access determiner 190 may then identify common identity management access items using the determined distribution. In particular, these common identity management artifacts can be identified by identifying outliers using a criteria (e.g., Tukey's criteria) and applying the criteria to the distribution of the concurrency degrees for the identity management artifacts.

In one embodiment, common access determiner 190 may remove extreme outlier identity management artifacts from this distribution before common identity management access items are identified (e.g., to remove the tail of the distribution). Then the upper quartile (or some other portion) of the trimmed distribution can be taken to identify outliers that may be common access identity management artifacts. In some embodiments, then, the (e.g., Tukey) criteria may be applied twice: once to remove the “long tail” of the distribution and once to identify Q3 (or some other portion) of the trimmed distribution. Once the common access identity management artifacts are identified, common access determiner 190 may present these common access identity management artifacts to a user (e.g., through an interface or otherwise).

Common access determiner 190 may also be adapted to determine unique access items (e.g., roles or entitlements) in a similar manner. These unique access items may be relatively exclusive (e.g., rarely granted) with the set of access items of the enterprise. These unique roles (or other access items) may be identified by identifying those roles that have a concurrency (e.g., degree) that is below some threshold. Such unique access items may also be identified through analysis of identity graph 192 to determine nodes of identity graph 192 associated with such access items that are singletons or have less than a threshold number of relationships with other identity management artifacts of identity graph 192. Such unique roles may also be presented to a user.

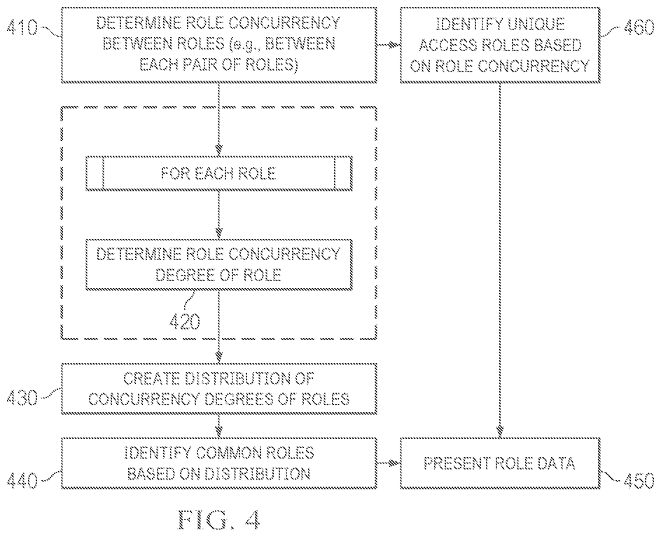

FIG. 4 is a flow diagram for one embodiment of a method for determining common or unique access items. While this embodiment will be illustrated with respect to roles (e.g., collection of entitlements) similar embodiments may be applied to entitlements or other access items (i.e., identity management artifacts) without loss of generality. In determining the commonality of roles the concurrency of roles in terms of identities that have those roles may be utilized in some embodiments. This concurrency may be expressed between roles as a measure of shared identities.

Accordingly, at step 410 role concurrency may be determined between each pair of roles being evaluated (e.g., a set of roles in the enterprise, a set of roles in a group or division of an enterprise such as a location, or some other definition used for segmenting roles). This concurrency is a measure of the number of identities shared between the pair of roles. Again, this concurrency may be thought of as the Jaccard similarity of the roles based on the identities which have been assigned those roles (e.g., the identities that share that role).

At step 420, the concurrency degree for each role can then be determined based on the concurrency between that role and each other role. Specifically, the (role) concurrency degree for a role may be the number of other roles that have a concurrency with that role that is above some threshold (e.g., which may be user or algorithmically determined, may be adjustable, etc.).

Using the concurrency degrees determined for each role, the distribution of roles based on the concurrency degrees determined for the roles can be created at step 430. Common roles can then be identified using this distribution at step 440. In particular, these common roles can be identified by identifying outliers by applying Tukey's criteria to the distribution of the concurrency degrees for the roles.

In one embodiment, extreme outlier roles can be removed from this distribution before common roles are identified (e.g., to remove the tail of the distribution). Then the upper quartile (or some other portion) of the trimmed distribution can be taken to identify outliers that may be common access roles. In some embodiments, then, the Tukey criteria may be applied twice: once to remove the “long tail” of the distribution and once to identify Q3 (or some other portion) of the trimmed distribution. Once the common access roles are identified they may be presented to a user (e.g., through an interface or otherwise) at step 450.

Similarly, in some cases, unique access items (e.g., roles or entitlements) may also be identified. These unique access items may be relatively exclusive (e.g., rarely granted) with the set of access items of the enterprise. These unique roles (or other access items) may be identified at step 460 by identifying those roles that have a concurrency that is below some threshold. Such unique access items may also be identified through analysis of an identity graph to determine nodes associated with such access items that are singletons or have less than a threshold number of relationships with other identity management artifacts of the identity graph. Such unique roles may also be presented to a user at step 450.

As discussed, embodiments of a method for identifying common access items have certain issues, including the possibility of skewed distribution, scalability issues, and perhaps most problematically reliance on representations of the identity management structure of an enterprise that may be maintained or created by the enterprise itself. To ameliorate such issues, among other benefits, embodiments for determining common or unique access items may employ a machine learning model (such as an isolation forest model or extended isolation forest model for example) trained on identity management data obtained from an enterprise, where that machine learning model may be trained to, and utilized for, generating predictive scores for commonality for access items.

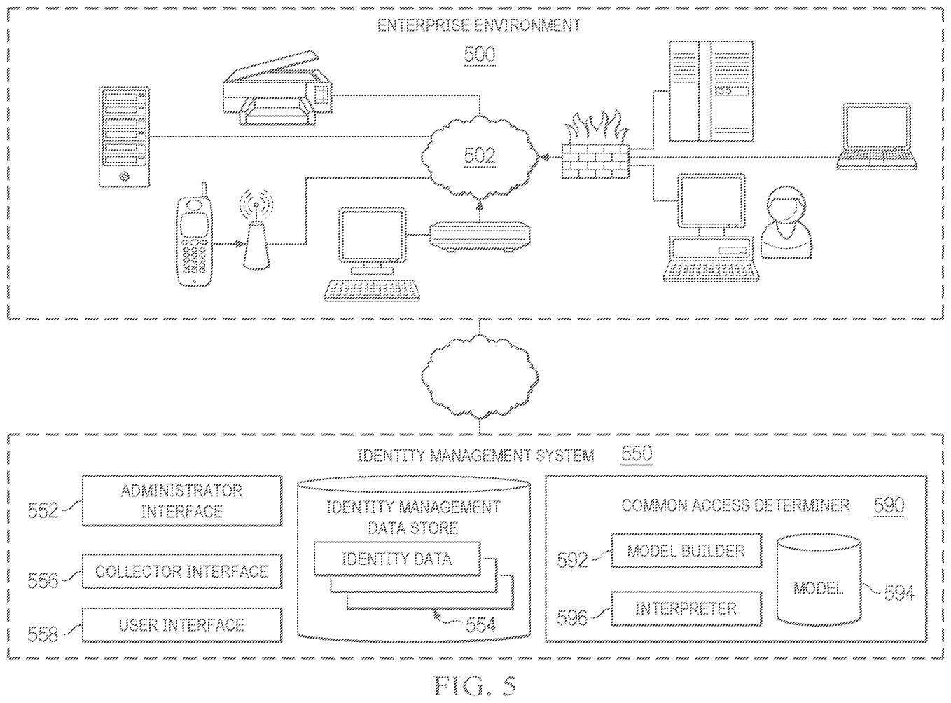

FIG. 5 depicts a distributed networked computer environment including one embodiment of an identity management system for determining common or unique access items based on identity management data obtained from the enterprise environment. Aspects of the networked computer environment and identity management system may be similar to those described above with respect to FIG. 1. Again, then, the networked computer environment may include an enterprise computing environment 500 including a number of computing devices or applications that may be coupled over a computer network 502.

To assist in managing the entitlements assigned to various users and more generally in managing and assessing access risks in enterprise environment 500, an identity management system 550 is provided. Such an identity management system 550 may include an administrator interface 552 and store identity management data 554 (e.g., as obtained from source systems within enterprise 500). The identity management data 554 stored may include a set of entries, each entry corresponding to and including an identity (e.g., alphanumeric identifiers for identities) as defined and managed by the identity management system, a list or vector of entitlements or roles assigned to that identity by the identity management system, and a time stamp at which the identity management data was collected from the identity management system. Other data could also be associated with each identity, including data that may be provided from other systems such as a job title, location or department associated with the identity. The set of entries may also include entries corresponding to roles, where each entry for a role may include the role identifier (e.g., alphanumeric identifier or name for the role) and a list or vector of the entitlements associated with each role. Other data could also be associated with each role, such as a title, location or department associated with the role.

Collectors 556 of the identity management system 150 are thus adapted to request or otherwise obtain data from various touchpoint (source) systems within enterprise environment 500. A user may interact with the identity management system 550 through a user interface 558 to access or manipulate data on identities, roles, entitlements, events or generally perform identity management with respect to enterprise environment 150.

Identity management system 550 may also include common access determiner 590 adapted to utilize identity management data 554 for enterprise 500 stored in graph data to determine one or more common or unique identity management artifacts (i.e., common or unique access items) of enterprise 500.

Common access determiner 590 may thus include a model builder 592 adapted to train a machine learning model 594 based on identity management data 554 or a portion thereof. Initially then, model builder 592 may prepare training data for the training machine learning model 594 from identity management data 554. For example, when it is desired to determine common or unique entitlement of enterprise 500, training data including entitlements from identity management data 554 may be prepared.

Specifically, identity management data 554 may include entitlements, each identity having (or not having) such an entitlement, the job titles (or other identifier of a grouping) of each identity, or other identity management data. Based on this identity management data 554, training data may be determined. This training data may include a feature data point for each combination of entitlement and job title. Specifically, in one embodiment, the training data for model 594 may be a popularity for each entitlement for each job title. In one embodiment, the popularity of the entitlement for a job title may be a measure (e.g., a percentage) of identities that have that job title that have been assigned that entitlement. In other words, the training data may include rows corresponding to entitlements and columns corresponding to each job title, where that data point for a cell is a measure of popularity of that entitlement for that job title based on identities that have that job title (and that are, or are not, assigned that entitlement).

Thus, the number of dimensions in the training data for each entitlement may be the number of job titles utilized. In one embodiment, to reduce the dimensionality of the training data, model builder 592 may perform job title coalescing or consolidation (e.g., based on Natural Language Processing (NLP) or some other technique) such that the popularity can be determined based on determined combinations of job titles instead of those individual job titles.

Specifically, model builder 592 may cluster job titles assigned across identities in identity management data 554, where each resulting cluster of job titles represents a “family” of job titles. Not only does this clustering reduce biases introduced from use of individual job titles that actually may be quite close (e.g., “software engineer 1”, software engineer 2″) but such clustering may also reduce that size of the training data (e.g., the number of columns in the data set) and make training of model 594 more efficient.

Specifically, in one embodiment model builder 592 may utilize a job title score for each job title determined based on values assigned to tokens of a job title or an edit distance (e.g., Levenshtein distance) between two or more job titles to cluster related job titles. This cluster of job titles may then be assigned a cluster identifier. Model builder 592 can then determine the popularity of the entitlement for each cluster of job titles, where the popularity may be a measure (e.g., a percentage) of identities that have a job title within that cluster that have been assigned that entitlement. In other words, the training data may include rows corresponding to entitlements and columns corresponding to each cluster of job titles, where that data point for a cell is a measure of popularity of that entitlement for that cluster of job title based on identities that have any of the job titles assigned to that cluster (and that are, or are not, assigned that entitlement). In some embodiments, when clustering job titles, any job titles that cannot be clustered with any other job titles may themselves be clustered together under a single cluster identifier (e.g., a “singleton” cluster identifier or the like). The popularity of each entitlement for the singleton cluster of job titles can then be determined by the popularity of identities that have a job title within that singleton cluster that have been assigned that entitlement.

To illustrate with some example data, Appendix A depicts clusters of job titles along with their associated cluster identifier (e.g., T-0, T-1, etc.). Appendix B illustrates an example set of training data, with rows corresponding to entitlements and columns corresponding to job title clusters (e.g., T-22, etc.) where the values for each cell are the popularity of that entitlement within that job cluster.

Using the determined training data then, model builder 592 may train a predictive machine learning model 594 (e.g., an isolation forest or extended isolation forest model). It will be noted that model builder 592 may train model 594 repeatedly or update model 594 at different times (e.g., a first time and a second time) based on new, updated, or different identity management data 554. Once the machine learning model 594 is trained it can be applied to (e.g., feature data for) an entitlement to generate a predictive score (e.g., predictive of the commonality of that entitlement or how much of an outlier that entitlement is). Appendix C depicts example predictive scores for entitlements that may be generated by embodiments of model 594. If a predictive score generated for an entitlement is greater (or less) than a threshold the entitlement may be determined to be a common (or unique) access item. Such common or unique access items may be presented to a user (e.g., through an interface of the identity management system 550

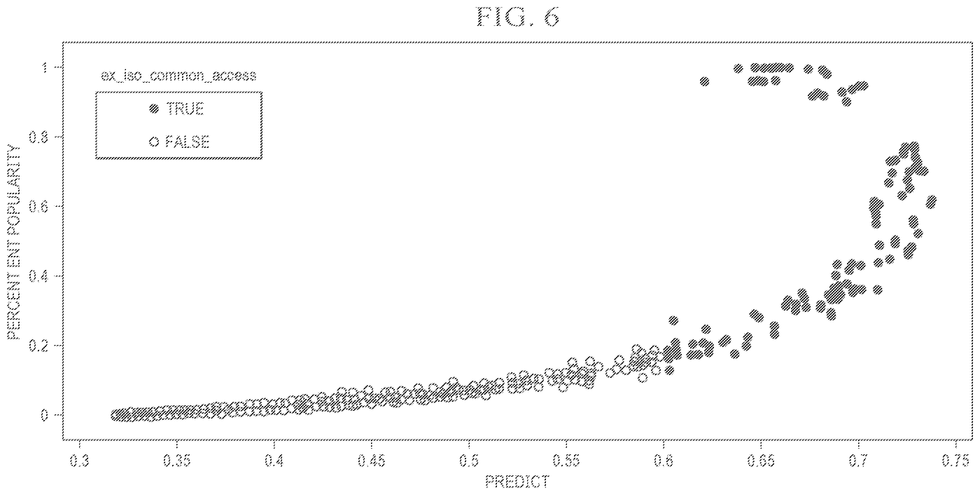

A predict score generated by an iso forest machine learning model may be thought of as a representative of how easy or hard it is to find that data point in the set of entitlements (e.g., —how much of an “outlier” that entitlement is with respect to the entire set of entitlements). Thus, the determination of a predictive score threshold to utilize for a common access threshold (e.g., a predictive score threshold above which an entitlement with that score should be considered a common access item) or a unique access threshold (e.g., a predictive score below which an entitlement with that score should be considered a unique access item) may be determined based on the predictive scores themselves. To illustrate, FIG. 6 depicts an example plot of entitlements and predict scores from example data. Each data point is an entitlement where the y axis is the total popularity of said entitlements and the x axis is a predict score from an iso forest machine learning model. A common access or unique access threshold may be based on the predict scores and global popularity of the set of entitlements. To determine such a threshold, common access determine 590 may analyze the predict score of a most popular (or least popular) entitlement or a most popular (or least popular) set of entitlements (e.g., highest scoring one or highest scoring set of entitlements for a common access threshold or lowest scoring one or lowest scoring set of entitlements for a unique access threshold). Threshold selection may be automated, based on input from a user, or otherwise selected. The common access threshold (or unique access threshold) may then be determined based on the predict scores of the most popular or set of most popular entitlements (or least popular or set of least popular entitlements), for example, by taking a highest predict score as the threshold, averaging the top set of predict scores and taking that as the threshold, using a percentage of the top predict score, using a percentage of the average of the top set of predict scores, or by some other algorithmic determination of the common access threshold based on the predict score of the most popular entitlement or the set of predict scores of the most popular entitlements, etc.).

Returning to FIG. 5, in some cases, then, as a user may be presented with a common or unique access item with little surrounding context as to how the common or unique access item was determine or what factors influenced the determination of the common or unique access item, it may be desirable to offer the user some degree of insight into the determination of the common or unique access item such as the features that influenced the determination of those common or unique access items.

Accordingly, when common or unique access items are returned from the identity management system 550 to the user through a user interface 558, the user interface 558 may offer an interface to allow a user to obtain additional information on one or more of the provided common or unique access item (e.g., referred to as an interpretation). Such an interpretation may be utilized by a user to probe a particular common or unique access item and be provided with the top or most influential features for that particular common or unique access item. This capability, in turn, may help the user to relate to the common or unique access item identified and incite confidence in the determination. Consequently, by providing such an interpretation, a user may gain confidence in the common or unique access items identified, and the identity management system 550 itself.

In some embodiments when the user requests such interpretations for one or more common or unique access items, these common or unique access items may be submitted to interpreter 596 in a request for an interpretation for those common or unique access items. In some embodiments, interpreter 596 may utilize a principle referred to as ‘Interpretability of Models’ whereby the interpreter 596 may be utilized as an independent process from the training of model 594. This interpreter 596 can be queried to provide explanations in terms of how much and what type (positive or negative) of influence did the features have over the determination of a common or unique access item.

For each common or unique access item interpreter 596 may build a localized model for that common or unique access item by querying the model 594 in a “neighborhood” of that common or unique access item to build a local generalized linear model for that common or unique access item out of what may be a highly non-linear model 594. This querying may be accomplished by determining values for a set of features associated with the model 594 (e.g., one or more of the same features used to train the model 594) and varying one or more of these values within a tolerance for a plurality of requests to the model 594 to determine values for the set of features that are close, but not the same as, the values for those features associated with the common or unique access item itself.

In one embodiment, the interpreter 596 may be, for example, based on Local Interpretable Model-Agnostic Explanations (LIME) or Shapley Additive exPlanations (SHAP). Embodiments of such a localized model may, for example, be a logistic regression model or the like with a set of coefficients for a corresponding set of features. While such an approximation may be valid within a small neighborhood of the common or unique access item, the coefficients of the approximate (e.g., linear) model may be utilized to provide the most influential features. A feature corresponding to a coefficient of the localized model with a large magnitude may indicate a strong influence, while the sign of the coefficient will indicate whether the effect of the corresponding feature was positive or negative. Based on the magnitude or signs of the coefficients associated with each feature of the localized model for the common or unique access item a top number (e.g., top 2, top 5, etc.) of influential features (e.g., positive or negative) may be determined.

The top set of features that resulted in the determination of that access item as a common or unique access item may then be returned such that the top features can be displayed to the user through the user interface 558. In one embodiment, these features may be displayed along with their absolute or relative magnitude, in for example a histogram or other graphical presentation. Alternatively, an English language explanation associated with one or more of the determined features may be determined and presented in the interface.

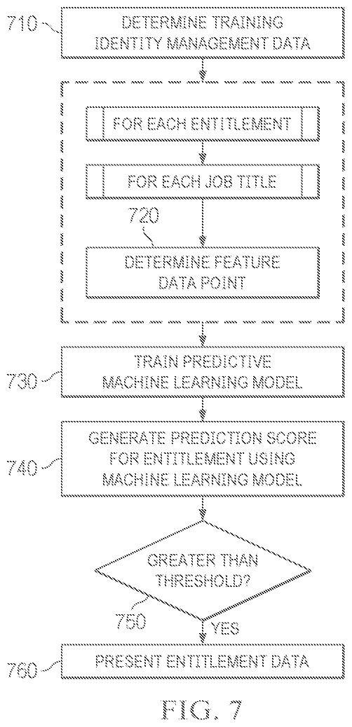

FIG. 7 depicts a flow diagram for an embodiment of a method for determining common access items using machine learning. While this embodiment will be illustrated with respect to entitlements similar embodiments may be applied to roles or other access items without loss of generality. In these types of embodiments, machine learning (e.g., unsupervised machine learning) may be applied to determine common access entitlements (again, similar embodiments may be applied to determine unique access items without loss of generality). Specifically, in certain embodiments an—(e.g., extended) isolation forest model may be trained to identify outlier data points in the multi-dimensional dataset. As each feature in a dataset may have a different distribution an isolation forest model can effectively combine such multiple distributions to essentially reduce multi-dimensional distributions to one distribution.

Thus, at step 710 identity management data for use in training the machine learning model may be obtained. This identity management data may include, for example, each entitlement of the identity management data, each identity having (or not having) such an entitlement, the job titles (or other identifier of a grouping) of each identity or other identity management data. Based on this identity management data training data may be determined. This determination may be a feature data point at step 720 for each combination of entitlement and job title. Thus, the determination of feature data to train the machine learning model may include, determining a popularity for each entitlement for each job title. In one embodiment, the popularity of the entitlement for a job title may be a measure (e.g., a percentage) of identities that have that job title that have been assigned that entitlement.

At step 730 a predictive machine learning model (e.g., isolation forest or extended isolation forest model) may be trained on the determined training data (e.g., as depicted in the Appendices). Once the machine learning model is trained, at step 740, it can be applied to (e.g., feature data for) an entitlement to generate a predictive score (e.g., predictive of the commonality of that entitlement or how much of an outlier that entitlement is). If that score is greater (or less) than a threshold (step 750) the entitlement may be presented to a user at step 760. Accordingly, embodiments may be highly scalable to a large number of access items (e.g., as the number of columns may be limited to job titles) and may be utilized for a relatively long amount of time before retraining may be desired.

Although the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments discussed herein can be implemented in a set of distributed computers communicatively coupled to a network (for example, the Internet). Any suitable programming language can be used to implement the routines, methods or programs of embodiments of the invention described herein, including R, Python, C, C++, Java, JavaScript, HTML, or any other programming or scripting code, etc. Other software/hardware/network architectures may be used. Communications between computers implementing embodiments can be accomplished using any electronic, optical, radio frequency signals, or other suitable methods and tools of communication in compliance with known network protocols.

Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such a computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

APPENDIX A

| cluster_id | title |
|---|---|
| T-0 | Project Manager |
| T-0 | IT Project Manager |
| T-0 | FAM Project Manager |
| T-0 | IT Operations Project Manager |
| T-0 | Associate Project Manager |
| T-0 | Procurement Project Manager |
| T-0 | Sr. Project Manager |
| T-0 | Manager, IT Project Management |
| T-0 | Senior Project Manager |
| T-0 | AI Project Manager |
| T-0 | Junior Project Manager |
| T-1 | Sales Executive |
| T-1 | Strategic Account Executive |
| T-1 | Strategic Sales Executive |
| T-1 | Corporate Account Executive |
| T-1 | Strategic Software Sales Executive |
| T-1 | Software Sales Executive |
| T-1 | Sr. Sales Executive |
| T-1 | Enterprise Account Executive |
| T-1 | Sales Executive Agent |
| T-1 | Enterprise Sales Executive |
| T-1 | Account Executive |
| T-1 | Manager, Corporate Account Executive |
| T-1 | Enterprise Software Sales Executive |
| T-1 | Sales Executive Italy |
| T-1 | Sales Account Executive, Enterprise Sales |
| T-1 | Manager, Enterprise Software Sales |
| T-1 | Sales Account Executive |
| T-1 | AVP, Software Sales Enterprise |
| T-1 | Enterprise Account Executive |
| T-1 | Regional Sales Executive |
| T-1 | Director, Corporate Account Executive |
| T-10 | Engagement Manager, Professional Services |
| T-10 | Manager, Professional Services |
| T-10 | Area Director, Professional Services |
| T-10 | Sr. Manager, Professional Services |
| T-10 | PMO Manager, Professional Services |
| T-10 | Sr. Director, Professional Services |
| T-10 | Expert Services Engagement Manager |
| T-10 | Director, Professional Services |
| T-10 | Team Lead, Professional Services |
| T-10 | Professional Services Intern |
| T-10 | Professional Services Manager |
| T-10 | RMO Manager, Professional Services |
| T-11 | General Counsel |
| T-11 | Counsel, Privacy |
| T-11 | Assistant General Counsel |
| T-11 | Associate General Counsel, Corporate |
| T-11 | Deputy General Counsel |
| T-11 | Associate General Counsel, Privacy |
| T-12 | Consultant |
| T-12 | Senior Consultant |
| T-12 | Associate Consultant |
| T-13 | Associate Demo Engineer |
| T-13 | Demo Engineer |
| T-13 | Demo Engineer Intern |
| T-14 | Associate Lead Test Engineer |
| T-14 | Lead Test Engineer |
| T-14 | Associate Lead Automation Engineer |
| T-14 | Senior Test Engineer |
| T-14 | Sr Staff Test Engineer |
| T-14 | Automation Test Engineer II |
| T-14 | Senior Automation Engineer |
| T-14 | Test Engineer II |
| T-14 | Staff Test Engineer |
| T-14 | Sr Test Engineer |
| T-14 | Test Engineer |
| T-14 | Senior Staff Test Engineer |
| T-14 | Sr. Test Engineer |
| T-14 | Sr. Automation Test Engineer |
| T-15 | Senior Software Engineer |
| T-15 | Associate Lead Software Engineer |
| T-15 | Software Engineer II |
| T-15 | Associate Software Engineer |
| T-15 | Lead Software Engineer |
| T-15 | Staff Software Engineer |
| T-15 | Software Engineer |
| T-15 | Principal Software Engineer |
| T-15 | Software Engineer Intern |
| T-15 | Software Engineer II-Devops |
| T-15 | Sr. Software Engineer |
| T-15 | Senior Staff Software Engineer |
| T-15 | Junior Software Engineer |
| T-15 | Sr Staff Software Engineer |
| T-15 | Senior Triage Engineer |
| T-15 | Software Triage Engineer |
| T-15 | Triage Engineer |
| T-15 | Sr. Staff Software Engineer |
| T-16 | Associate Manager, Accounting |
| T-16 | Sr. Manager, Accounting |
| T-16 | Manager, Accounting |
| T-17 | Customer Success Manager |
| T-17 | Director, Customer Success Management |
| T-17 | Manager, Customer Success Management |
| T-17 | Senior Customer Success Manager |
| T-17 | Sr. Manager, Customer Success Management |
| T-17 | Sr. Manager, Customer Success Engineering |
| T-17 | Associate Manager, Customer Success Management |
| T-17 | Team Lead, Customer Success Management |
| T-17 | Strategic Customer Success Manager |
| T-17 | Sr. Customer Success Manager |
| T-17 | Director, Customer Success Strategy |
| T-17 | Technical Customer Success Manager |
| T-17 | Sr. Director, Customer Success Management |
| T-17 | Sr. Manager, Customer Success Operations |
| T-18 | Associate Manager, Cybersecurity Strategy and Risk |
| | Sr. Manager, Cybersecurity Strategy, Governance, and |
| T-18 | Risk |
| T-19 | Associate Manager, Deal Strategy and Operations |
| T-19 | Manager, Deal Strategy and Operations |
| T-2 | Senior Accountant |
| T-2 | Staff Accountant |
| T-2 | Accountant |
| T-20 | Manager, DevOps |
| T-20 | Associate Manager, DevOps |
| T-21 | Manager, Engineering |
| T-21 | Manager, Inside Sales DACH |
| T-21 | Manager, Solution Engineering |
| T-21 | Associate Manager, Sales Enablement |
| T-21 | Senior Engineering Manager |
| T-21 | Software Engineering Manager |
| T-21 | Senior Software Engineering Manager |
| T-21 | Sales Enablement Program Manager |
| T-21 | Manager, Sales Engineering |
| T-21 | Sr. Manager, Engineering |
| T-21 | Sr. Manager, Sales |
| T-21 | Sr. Manager, Sales Engineering |
| T-21 | Sr. Manager, Demo Engineering |
| T-21 | Manager, Digital Sales |
| T-21 | Manager, Sales |
| T-21 | Senior Sales Enablement Manager |
| T-21 | Manager, Test |
| T-21 | Senior Manager, Sales Support |
| T-21 | Engineering Manager |
| T-21 | Associate Manager, Engineering |
| T-21 | Team Lead, Demo Engineering |
| T-21 | Digital Sales Manager |
| T-21 | Sales Manager |
| T-21 | Sr. Manager, Solution Engineering |
| T-21 | Sr. Manager, Sales Planning |
| T-21 | Sales Enablement Manager |
| T-21 | Sr. Manager, Digital Sales |
| T-21 | Manager, Sales Operations |
| T-21 | Manager, Test Engineering |
| T-21 | Manager, Triage Engineering |
| T-21 | Sr. Software Engineering Manager |
| T-21 | Manager, Inside Sales |
| T-21 | Sr. Manager, Data Engineering |
| T-21 | Manager, Performance Engineering |
| T-21 | Associate Manager, Sales Operations |
| T-21 | Manager, France Sales |
| T-22 | Manager IT Operations |
| T-22 | Associate Manager, IT |
| T-22 | Associate Manager, IT Operations |
| T-22 | Senior Manager IT Operations |
| T-23 | IT Network/Security Engineer |
| T-23 | Associate Manager, IT Network/Security |
| T-24 | Associate Order-to-Cash (Renewals) |
| T-24 | Manager, Order-to-Cash â€″ Billing and Renewals |
| T-24 | Associate, Order-to-Cash â€″ Billing and Renewals |
| T-24 | Senior Manager, Order-to-Cash |
| T-24 | Senior Associate, Order-to-Cash |
| | Associate Manager, Order-to-Cash â€″ Billing and |
| T-24 | Renewals |
| T-24 | Sr. Director, Order-to-Cash |
| T-24 | Lead Associate, Order-to-Cash â€″ Billing and Renewals |
| T-25 | Manager, Talent Acquisition |
| T-25 | Associate Manager, Talent Acquisition |
| T-26 | Associate Product Designer |
| T-26 | Sr. Product Designer |
| T-26 | Product Designer II |
| T-26 | Lead Product Designer |

APPENDIX B

| entitlement_id | singleton | T-28 | T-8 | T-6 | T-0 | T-15 | T-44 |
|---|---|---|---|---|---|---|---|
| ent-0 | 0.015337 | 0 | 0 | 0 | 0 | 0 | 0 |
| ent-1 | 1 | 1 | 1 | 1 | 1 | 1 | 1 |
| ent-2 | 0.046012 | 0 | 0.333333 | 0 | 0 | 0.253061 | 0 |
| ent-3 | 0.09816 | 0.333333 | 0.026667 | 0.311475 | 0.111111 | 0 | 0.1 |
| ent-4 | 0.932515 | 0.866667 | 0.64 | 0.918033 | 1 | 0.726531 | 1 |
| ent-5 | 0.006135 | 0 | 0 | 0 | 0 | 0 | 0 |
| ent-6 | 0.116564 | 0 | 0.013333 | 0.114754 | 0.148148 | 0.085714 | 0 |
| ent-7 | 0.015337 | 0 | 0.04 | 0 | 0 | 0.016327 | 0 |
| ent-8 | 1 | 1 | 1 | 1 | 1 | 1 | 1 |
| ent-9 | 0.015337 | 0.066667 | 0 | 0.098361 | 0 | 0 | 0 |
| ent-10 | 0 | 0 | 0 | 0 | 0 | 0.020408 | 0 |
| ent-11 | 0.220859 | 0.066667 | 0.893333 | 0.180328 | 0.444444 | 0.502041 | 0 |
| ent-12 | 0.392638 | 0.133333 | 0.12 | 0.04918 | 0.555556 | 0.102041 | 0.5 |
| ent-13 | 0.546012 | 0.133333 | 0.133333 | 0.114754 | 0.37037 | 0.004082 | 0.1 |
| ent-14 | 0.358896 | 0.133333 | 0.173333 | 0.016393 | 0.518519 | 0.236735 | 0.6 |

APPENDIX C

| entitlement_id | predict |
|---|---|
| ent-0 | 0.316554381 |
| ent-1 | 0.539915067 |
| ent-2 | 0.392438308 |
| ent-3 | 0.513565806 |
| ent-4 | 0.705213379 |
| ent-5 | 0.380508157 |
| ent-6 | 0.516093837 |
| ent-7 | 0.320069961 |
| ent-8 | 0.539915067 |
| ent-9 | 0.325815405 |
| ent-10 | 0.317356887 |
| ent-11 | 0.659140501 |
| ent-12 | 0.667011183 |
| ent-13 | 0.678092059 |
| ent-14 | 0.645408149 |
| ent-15 | 0.539915067 |

What is claimed is:

1. An identity management system, comprising:
a data store;
a processor;
a non-transitory, computer-readable storage medium including computer instructions for:
obtaining identity management data from one or more source systems in an enterprise computing environment, the identity management data comprising data on a set of identity management access items associated with the enterprise computing environment, the identity management access items comprising a set of identities, a set of entitlements associated with the set of identities, or a set of roles associated with the set of entitlements, wherein the set of identities, set of entitlements or set of roles are utilized in identity management for the enterprise computing environment; and
evaluating the identity management data to determine a common or unique access item of the set of identity management access items.

2. The identity management system of claim 1, wherein determining the common or unique access item comprises:
determining concurrency of the set of identity management access items;
determining a distribution of the set of identity management access items based on the concurrency; and
determining the common or unique access item based on the distribution of the set of identity management access items.

3. The identity management system of claim 2, wherein the instructions further comprise instructions for: generating a network identity graph from the identity management data, wherein the concurrency of the set of identity management access items is based on the network identity graph.

4. The identity management system of claim 1, wherein the instructions further comprise instructions for:
training a machine learning model to generate a predictive score for each of the set of identity management access items; and
determining the common or unique access item based on the predictive scores for each of the set of identity management access items by comparing the predictive scores to a threshold.

5. The identity management system of claim 4, wherein the machine learning model is trained based on a popularity of each of the set of identity management access items.

6. The identity management system of claim 5, wherein the threshold is determined based on the predictive scores for each of the set of identity management access items.

7. The identity management system of claim 4, wherein the instructions further comprise instructions for determining a top set of features that resulted in the determination of the common or unique access item.

8. An method, comprising:
obtaining identity management data from one or more source systems in an enterprise computing environment, the identity management data comprising data on a set of identity management access items associated with the enterprise computing environment, the identity management access items comprising a set of identities, a set of entitlements associated with the set of identities, or a set of roles associated with the set of entitlements, wherein the set of identities, set of entitlements or set of roles are utilized in identity management for the enterprise computing environment; and
evaluating the identity management data to determine a common or unique access item of the set of identity management access items.

9. The method of claim 8, wherein determining the common or unique access item comprises:
determining concurrency of the set of identity management access items;
determining a distribution of the set of identity management access items based on the concurrency; and
determining the common or unique access item based on the distribution of the set of identity management access items.

10. The method of claim 9, further comprising generating a network identity graph from the identity management data, wherein the concurrency of the set of identity management access items is based on the network identity graph.

11. The method of claim 8, further comprising:
training a machine learning model to generate a predictive score for each of the set of identity management access items; and
determining the common or unique access item based on the predictive scores for each of the set of identity management access items by comparing the predictive scores to a threshold.

12. The method of claim 11, wherein the machine learning model is trained based on a popularity of each of the set of identity management access items.

13. The method of claim 12, wherein the threshold is determined based on the predictive scores for each of the set of identity management access items.

14. The method of claim 11, further comprising determining a top set of features that resulted in the determination of the common or unique access item.

15. A non-transitory computer-readable storage medium including computer instructions for:
obtaining identity management data from one or more source systems in an enterprise computing environment, the identity management data comprising data on a set of identity management access items associated with the enterprise computing environment, the identity management access items comprising a set of identities, a set of entitlements associated with the set of identities, or a set of roles associated with the set of entitlements, wherein the set of identities, set of entitlements or set of roles are utilized in identity management for the enterprise computing environment; and
evaluating the identity management data to determine a common or unique access item of the set of identity management access items.

16. The non-transitory computer-readable storage medium of claim 15, wherein determining the common or unique access item comprises:
determining concurrency of the set of identity management access items;
determining a distribution of the set of identity management access items based on the concurrency; and
determining the common or unique access item based on the distribution of the set of identity management access items.

17. The non-transitory computer-readable storage medium of claim 16, wherein the instructions further comprise instructions for: generating a network identity graph from the identity management data, wherein the concurrency of the set of identity management access items is based on the network identity graph.

18. The non-transitory computer-readable storage medium of claim 15, wherein the instructions further comprise instructions for:
training a machine learning model to generate a predictive score for each of the set of identity management access items; and
determining the common or unique access item based on the predictive scores for each of the set of identity management access items by comparing the predictive scores to a threshold.

19. The non-transitory computer-readable storage medium of claim 18, wherein the machine learning model is trained based on a popularity of each of the set of identity management access items.

20. The non-transitory computer-readable storage medium of claim 19, wherein the threshold is determined based on the predictive scores for each of the set of identity management access items.

21. The non-transitory computer-readable storage medium of claim 18, wherein the instructions further comprise instructions for determining a top set of features that resulted in the determination of the common or unique access item.
